(19) United States
(12) Patent Application Publication
(10) Pub. No.: US 2025/0232471 A1
(43) Pub. Date: Jul. 17, 2025

(54) VISUAL LOCALIZATION OF IMAGE VIEWPOINTS IN 3D SCENES USING NEURAL REPRESENTATIONS

(71) Applicant: Nvidia Corporation, Santa Clara, CA (US)

(72) Inventors: Qunjie Zhou, Munich (DE); Maxim Maximov, Munich (DE); Or Litany, Haifa (IL); Laura Leal-Taixe, Florence (IT)

(21) Appl. No.: 19/015,191

(22) Filed: Jan. 9, 2025

Related U.S. Application Data
(60) Provisional application No. 63/620,683, filed on Jan. 12, 2024.

(51) Int. Cl. G06T 7/73

(52) U.S. Cl. CPC G06T 7/74; G06T 2207/20016; G06T 2207/20076; G06T 2207/20081; G06T 2207/30244

(57) ABSTRACT

Approaches presented herein provide for visual localization by matching features of a query image with features obtained from representation of a three-dimensional (3D) environment. A model such as a neural radiance field (NeRF) can be trained to represent the 3D environment. When a query image is received, query features can be extracted at two different resolutions. A lower resolution set of query features can be compared against NeRF descriptor features for a set of training images, to narrow the search space by finding a set of coarse matches. Higher resolution query features can then be compared against sampled features of these coarse matches, to identify 2D-3D correspondences that can be used to calculate camera pose information for the query image.

### CROSS-REFERENCE TO RELATED APPLICATIONS

This application claims priority to co-pending U.S. Provisional Patent Application Ser. No. 63/620,683, filed Jan. 12, 2024, and entitled “Exploring NeRF Features for Visual Localization,” which is hereby incorporated herein in its entirety and for all purposes.

### BACKGROUND

In various applications—such as for gaming, animation, or virtual reality content generation, for example—it can be beneficial, if not necessary, to represent complex three-dimensional scenes in a way that is substantially accurate, or at least consistent, even for large or complex scenes or environments. This often includes the training or generation of a complex three-dimensional (3D) model that represents a specific scene or environment, where the model might be generated using a set of two-dimensional (2D) images captured from different points of view with respect to the scene or environment. In certain use cases, a 2D image might be provided that includes a 2D view of a 3D scene or environment from a specific viewpoint. This viewpoint may be different from that represented in any 2D image that was originally used to generate the 3D representation. Prior visual localization processes use a set of reference images of a scene and a 3D point cloud with descriptors to provide 2D-3D matching, but while these techniques can be highly accurate they are demanding in storage due to the explicit scene representation, which limit its real-life applications at scale. While an end-to-end regression method can be used to improve efficiency by encoding a scene using a compact neural network, such learned scene representations lack interpretability needed for accurate visual localization.

### BRIEF DESCRIPTION OF THE DRAWINGS

Various embodiments in accordance with the present disclosure will be described with reference to the drawings, in which:

FIGS. 1A-1C illustrate example images from different views of an environment, according to at least one embodiment;

FIG. 2 illustrates components of an example system that can be used to perform visual localization, according to at least one embodiment;

FIG. 3A illustrates viewpoints that can be used for coarse matching against a query image, according to at least one embodiment;

FIG. 3B illustrates NeRF features extracted from a pre-trained NeRF model, according to at least one embodiment;

FIG. 4 illustrates an example process for performing visual localization, according to at least one embodiment;

FIGS. 5A and 5B illustrate components of an example content generation system, according to at least one embodiment;

FIG. 6 illustrates components of a distributed system that can be utilized to generate and provide image content, as well as to provide for visual localization, according to at least one embodiment;

FIG. 7A illustrates inference and/or training logic, according to at least one embodiment;

FIG. 7B illustrates inference and/or training logic, according to at least one embodiment;

FIG. 8 illustrates an example data center system, according to at least one embodiment;

FIG. 9 illustrates a computer system, according to at least one embodiment;

FIG. 10 illustrates a computer system, according to at least one embodiment;

FIG. 11 illustrates at least portions of a graphics processor, according to one or more embodiments;

FIG. 12 illustrates at least portions of a graphics processor, according to one or more embodiments;

FIG. 13 is an example data flow diagram for an advanced computing pipeline, in accordance with at least one embodiment;

FIG. 14 is a system diagram for an example system for training, adapting, instantiating and deploying machine learning models in an advanced computing pipeline, in accordance with at least one embodiment; and

FIGS. 15A and 15B illustrate a data flow diagram for a process to train a machine learning model, as well as client-server architecture to enhance annotation tools with pre-trained annotation models, in accordance with at least one embodiment.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

The systems and methods described herein may be used by, without limitation, non-autonomous vehicles, semi-autonomous vehicles (e.g., in one or more advanced driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types. Further, the systems and methods described herein may be used for a variety of purposes, by way of example and without limitation, for machine control, machine locomotion, machine driving, synthetic data generation, model training or updating, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, generative AI with large language models (LLMs) or vision language models (VLMs), light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medical systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing generative AI operations using LLMs, systems for performing light transport simulation, systems for performing collaborative content creation for 3D assets, systems implemented at least partially using cloud computing resources, and/or other types of systems.

Approaches in accordance with various embodiments can be used to generate one or more parameters for a content generation environment. In at least one embodiment, a trained machine learning (ML) and/or artificial intelligence (AI) system, such as a large language model (LLM) or a vision language model (VLM), may be used to generate parameters for the content generation environment, such as, but not limited to, camera settings, scene lighting, video parameters, and/or the like, used for displaying objects within a scene. The parameters may be based on an input provided by a user or a proxy for a user to a trained language model (e.g., LLM, VLM, etc.) that can then generate one or more settings in accordance with the input. Various embodiments may be used to generate settings in two-dimensional (2D) or three-dimensional (3D) settings. For embodiments that incorporate one or more language models—that is, one or more LLMs, one or more VLMs, or a combination of LLMs and VLMs, the language model(s) may receive an input (e.g., a prompt, a request, a query, etc.) that is parsed or otherwise formatted to generate a deterministic output. For example, the input provided to the language model may include a particular format for the output results, an example of desired output results, a particular list of parameters and their respective formatting, and the like. An input generator (e.g., a prompt generator), which may be driven or otherwise guided by one or more AI and/or ML systems, may be used to generate this input based on an initial input received from a user, a device, a proxy, and/or the like. A modified input generated by the input generator may then be provided to the language model, which will generate an output set of parameters. This output may be further evaluated with a reviewer, or other system, to ensure that the output is appropriate. Thereafter, a configuration file may be generated and/or the parameters may be directly provided to an environment to configure different components (e.g., camera settings, lighting, etc.) based on the parameters generated by the language model.

In some examples, the machine learning model(s) (e.g., deep neural networks, language models, LLMs, VLMs, multi-modal language models, perception models, tracking models, fusion models, transformer models, diffusion models, encoder-only models, decoder-only models, encoder-decoder models, neural rendering field (NERF) models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or at least one model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring).

The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

Approaches in accordance with various illustrative embodiments provide for two-dimensional (2D) visual localization with respect to a three-dimensional (3D) scene or environment. In particular, various embodiments allow for determining a camera pose for a 2D query image with respect to a representation of a 3D environment. A neural radiance field (NeRF) can be trained to generate (or represent) an accurate reconstruction of a 3D environment (or scene), and can generate high-dimensional feature representations of 3D points in the environment. In response to a 2D query image being received, for example, a low resolution image feature map and/or vector (encoded from the 2D query image) can be compared against reference 3D feature vectors (of high dimensionality) obtained using the pre-trained NeRF model at a nearby reference pose determined by search for the image with the most similar appearance to the received query image. A set of coarse matches (e.g., between 3,600 matches between coarse image patches and 3D points) or rough estimates of localization can be obtained from the comparison, such as may be based in part upon a distance (as may be calculated using a cosine similarity) between the vectors in a latent vector space. Once the coarse matches (e.g., 3D-to image patch matches) are determined, the coarse matches and a high resolution image feature vector can be sampled to obtain a set of input features that can be passed as input to a fine matching module. The fine matching module can perform matching at a higher feature resolution, such as by matching the sampled query image features against the sampled NeRF descriptors from the coarse matches to establish 2D-3D correspondences. These correspondences can be used to compute the camera pose of the query image with respect to the 3D environment, such as by using a PnP solver. The determination of camera pose for the query image effectively provides registration of the position from which the image was taken (or otherwise obtained or generated) with respect to a coordinate system of the environment. Such localization can be performed using a NeRF without any need to retrain the NeRF.

Variations of this and other such functionality can be used as well within the scope of the various embodiments as would be apparent to one of ordinary skill in the art in light of the teachings and suggestions contained herein.

There are many different operations or use cases where image content (or another such digital of virtual representation) is to be used to generate an accurate three-dimensional representation of one or more objects, as may include one or more foreground objects against one or more background objects in a three-dimensional environment. These “objects” can include digital representations of physical or virtual objects that can be used to generate images showing views of the objects from various locations of a virtual camera with respect to the environment. Objects to be represented may correspond to volumetric data representations or other such implicit representations. These implicit representations can be generated by a neural network, for example, such as a fully-connected neural radiance field (NeRF)-based generative network, often referred to simply as a “NeRF.” A trained NeRF can be used to generate novel views of objects, or scenes including multiple objects, from any appropriate point of view. These can correspond to at least some views that are “novel,” views that were not represented in training data used to train the NeRF, or views that were not otherwise previously encountered. NeRF inference in general relates to the computation of the radiance and density at given 3D positions with respect to a scene, as may include the integration over ray segments and outputting of different extended data, such as surface normals, segmentation identifiers, material parameters, or 3D motion data. There are various other ways to generate, provide, or render digital objects (or views of those objects) that can be used as well within the scope of various embodiments. A separate NeRF can be trained for each scene, environment, or object, and each NeRF can provide a separate NeRF descriptor for a respective scene using inherent features in the NeRF.

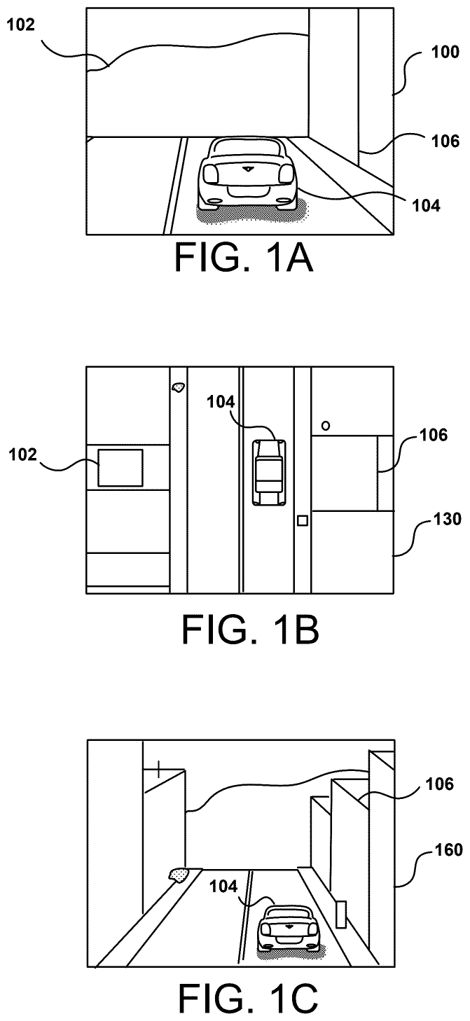

A NeRF can be trained to represent a 3D environment, which may be complex and/or large scale, using a set of 2D images captured (or generated) at various locations and orientations of a virtual camera with respect to the 3D environment. For example, FIGS. 1A and 1B illustrate images 100, 130 captured with different points of view of (or using different camera poses with respect to) an environment. Each of these images shows one or more objects, such as a vehicle 104 and a building 106, but from different angles and/or distances. There will be some objects, such as a hill 102 or a second building 102, which may not be present in both images 100, 130. A neural network (or other machine learning model) such as a NeRF can be trained using a set of such 2D images to effectively provide a virtual 3D representation of the 3D environment. The NeRF can be used to generate 2D images of the 3D environment from any appropriate point of view, even if the point of view differs from those represented in the 2D images used to train the NeRF.

It might be the case that a 2D query image 160 will be received, such as the query image 160 illustrated in FIG. 1C. A query image might be submitted when, for example, a user is located in (or proximate to) an object or vantage in the environment and takes an image with a smartphone or handheld camera, and it is desired to perform localization to determine where the user is in that physical environment. The query image can include a view of the 3D environment that may contain some of the same objects, such as the vehicle 104 and building 106 represented in at least one of the 2D training images. As illustrated, however, the query image 160 was captured (or otherwise generated) from a point of view that is different than that of any of the original 2D training images 100, 130. It may be desired to determine the location and/or orientation of a virtual camera that was used to obtain the query image. Because the query image does not exactly match any of the 2D training images, however, straightforward image matching may not be sufficient.

In at least one embodiment, a process such as visual localization can be performed to estimate the camera pose of a query image by, in part, matching (or otherwise comparing) the query image against a representation of the 3D environment. As mentioned, various prior approaches had deficiencies in aspects such as storage space demand or lack of interpretability. In at least one embodiment, visual localization can be performed using neural radiance fields (NeRF) as a prime scene representation, instead of relying on the use of multi-view images. A NeRF has advantages of being highly compact and interpretable, allowing use cases and applications in rendering scene views. Instead of simply using NeRF synthesized images for augmentation, a NeRF can be leveraged to directly provide the high-dimensional descriptors of scene three-dimensional (3D) points. A learning-based matching model can be used to directly match a query image against scene (internal) NeRF features, allowing for localization of the query-based 2D-3D correspondences. Such a NeRF-based approach can provide for lightweight, scalable and accurate localization.

It can be observed that the point of view of the query image 160 in FIG. 1C is closer to the point of view of a first training image 100 illustrated in FIG. 1A than the point of view of a second training image 130 illustrated in FIG. 1C. Image-level global matching (image retrieval) can be used to filter and quickly narrow the search space based on training images with similar points of view of an environment to the query 160. Coarse to fine matching from the query image to NeRF features can be performed within the narrowed search space (the nearest retrieved reference view), which can provide highly accurate results in a substantially more efficient manner than prior approaches. Various cross-domain correspondences can be established between image features and NeRF features, and inherently learned NeRF features can be used for localization. In contrast to prior approaches that only used a NeRF as a novel view synthesizer based on the NeRF predictions rather than its internal features, one or more embodiments of the present disclosure include a fine matching network that can be used to match image features with NeRF features. In at least one embodiment, a 2D-3D matching function can be learned to leverage the NeRF internal knowledge learned via view synthesis, building on top of the internal NeRF features. It has been observed that standard NeRF features are a good starting point for establishing 2D-3D matches to address the problem visual localization.

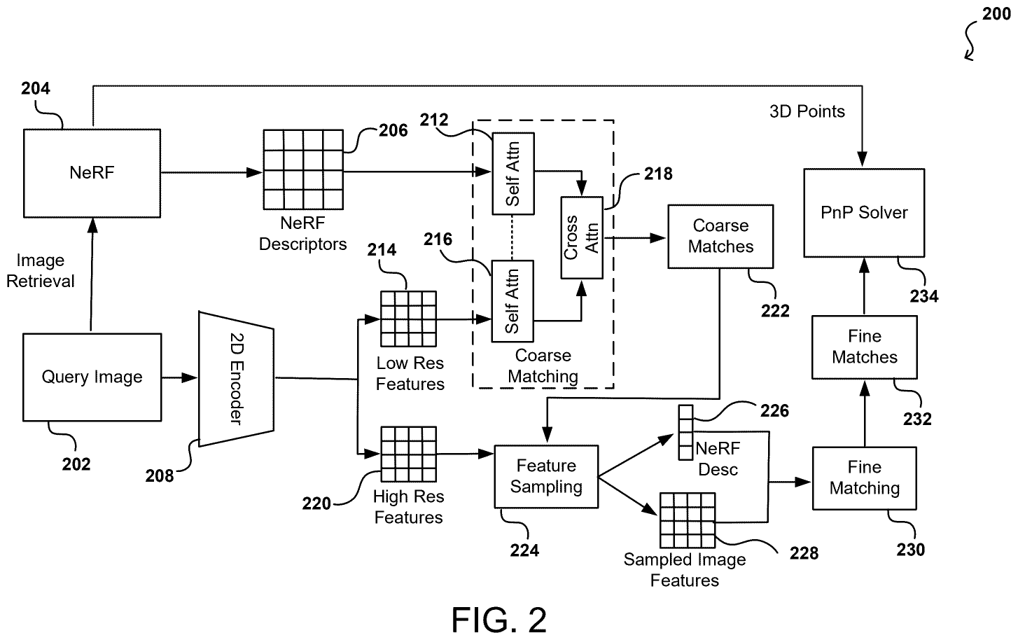

FIG. 2 illustrates an example system 200 that can be used to perform visual localization in accordance with at least one embodiment. Visual localization generally refers to the task of determining the camera pose of a query image with respect to a 3D environment. The ability to localize an agent in 3D space can be important for operations relating to robot navigation, autonomous driving, and augmented reality-based tasks, among others. Different localization solutions can be categorized based on their underlying scene representation. As an example, image retrieval represents a scene as a database of reference images with known camera poses. A more compact representation utilizes a 3D point cloud, where each point is triangulated from its 2D projections in multiple views. Structure-based methods typically rely on such a 3D model with associated keypoint descriptors to perform accurate localization. In some instances, dense 3D meshes have been integrated with structure-based localization, which provides the ability to switch between different descriptors to establish the 2D-3D correspondences. Different from these and other explicit scene representations, absolute pose regression (APR) and scene coordinate regression (SCR) methods can learn to encode scene information within network parameters, either directly in the localization network, or as a separate collection of latent codes as learned scene representation. Despite being more compact than a sparse point cloud and a 3D mesh, learned implicit scene representations are less interpretable and can only be used for the task of visual localization.

Neural Radiance Fields (NeRFs) can provide a powerful representation of complex scenes (e.g., 2D, 3D, or 4D scenes) encoded as continuous mapping of spatial coordinates to density and radiance. NeRF representations present several benefits, including high interpretability and highly compact nature. For example, one can easily render scene appearance and depth at any given viewpoint, using a multiscale (e.g., Mip-NeRF) model of 5.5 MB to represent a scene with a spatial extent ranging from 1 m² to 5 km². Owing in part to these and other attractive properties, NeRF can be used as a prime 3D scene representation, alongside meshes, point clouds, and multi-view images. Consequently, methods are being developed to operate directly on the NeRF representation, eliminating the need to revert the NeRF back into images or other 3D formats. These methods find use in a range of operations, including manipulation, registration, and perception.

In at least one embodiment, a NeRF representation can also be used for visual localization. Prior attempts to use NeRFs for visual localization have utilized a NeRF mainly as an auxiliary representation. For example, feature matching has been attempted by utilizing a combination of features extracted from a generalizable NeRF and projected multi-view features. Approaches in accordance with various embodiments presented herein can, as an initial or early step in a visual localization process, treat the NeRF as the primary scene representation. In particular, NeRF features can serve as an important component in such a process. NeRF features have the capability to effectively support point correspondences. One or more embodiments also include a matching transformer that can be used that can learn to align query image features with NeRF inner features. Such a NeRF-based matching process can achieve an average localization pose error of 14.5 cm/0.4° in one example, which is competitive with state-of-the-art outdoor localization methods. Further, when tested solely with NeRF synthesized images, despite an inherent visual gap, such an approach was observed to achieve comparable performance to real images in outdoor scenes and improved performance in indoor settings.

Prior structure-based localization approaches equip scene points with lifted multi-view 2D image features. Such approaches can facilitate robust matching against query images, as their features naturally lie in the same latent space. A prerequisite for utilizing these 2D descriptors is that the scene must also be reconstructed based on them, which constrains their applicability. Approaches in accordance with at least one embodiment, specifically for facilitating the localization of a query image against a scene represented by NeRF, do not rely on such pre-computed features. Instead, the inherent features of NeRF, known for their effectiveness in view synthesis, can be used as they can be directly useful for image matching.

At least one embodiment can use a NeRF-based localization pipeline for localization-related tasks. A NeRF 204 can be trained to represent a 3D scene or environment, such as by using a number of 2D images captured (or otherwise obtained or generated) having different views (or reference posed of a virtual camera) with respect to the environment. In the example of FIG. 2, a query image 202 is received that includes a 2D view of at least a portion of the scene or environment represented by the NeRF 204. The query image may be submitted by a user, for example, who captured the query image from a location within, or at least proximate, the 3D environment. Given the query image and a scene represented by the pretrained NeRF model associated with a list of pre-cached reference poses—such as the poses used to train the NeRF—a localization pipeline can perform at least three operations in order to localize the query image (e.g., determine pose information for the virtual camera for the query image) with respect to the environment.

A first task in accordance with at least one embodiment can involve performing image retrieval to extract visual descriptors from the query image and the reference images, as may be synthesized by the NeRF at all reference poses, to find the nearest neighbor to the query based in part on descriptor distances. Image retrieval can be performed, and features extracted from the query image and a set of reference images, using a generalized vector of locally aggregated descriptors (VLAD) layer such as NetVLAD. The extracted feature distances between the query image and the rendered reference images can be compared, with image retrieval being directly applied to the real reference images or rendered images with similar performance. In some embodiments the 2D training images may be cached for use, but in other embodiments the pose information for these images can be stored, and subsequently used by the trained NeRF to generate images corresponding to these poses. In at least one embodiment, there may be 1000 or more dimensional vectors encoded for a given query image.

For each reference pose, rays can be cast to render 3D points and associating features from the pre-trained NeRF scene representation. The image features can be extracted from the query image 202 in this example system using a 2D encoder 208 that can extract image features and encode those features into a latent representation, such as points in a latent space or one or more latent feature vectors. A feature pyramid network (FPN) may be used in some embodiments, which can take that latent representation of the query image and output proportionally sized feature maps at multiple levels or resolutions. In other embodiments, low and high resolution features can be obtained directly from the 2D encoder 208. As illustrated, a set of lower resolution features 214 can be extracted for the query image 202 to be used for a coarse matching process, while a set of higher resolution features 220 may be used for fine matching one a set of coarse matches has been determined. In at least one embodiment, there can be at least two learnable layers that can provide for downsampling in the feature dimension. As an example, point NeRF features in a feature map used for fine matching may have a resolution of 256 by default, but may need to be downsampled to a value such as 128, which is the dimension of a corresponding high resolution feature map. In at least one embodiment, a 2D CNN can reduce the feature map in resolution, such as by 16× or 32× downscaled resolution with respect to the original image. Fine matching can require higher resolution, and a component such as an FPN can provide the features in both the lower and higher resolutions. Other approaches can be used as well, such as by selecting earlier layers in the 2D encoder for processing. In at least one embodiment, directly using the earlier layer instead can be sufficient.

In at least one embodiment, image retrieval can efficiently narrow down the pose search space. A course matching process can then take as input the NeRF descriptors 206 and the low resolution image features 214 and process those using a set of self-attention layers 212 followed by at least one cross-attention layer 218. The result can be a set of coarse matches 222, which as mentioned can correspond to those 2D training images that were determined to be most similar in pose to that of the query image, such as may be based upon a number of closest matches, or matches within a specified similarity criteria or threshold, among other such options. The NeRF descriptors can be considered as a 3D point representation of the environment, while the image descriptor can be considered a 2D visual representation. A fine matching process can then attempt to match these representations. One example matching approach would be to use nearest neighbor matching involving multiplication of features in the representations. In this example, however, coarse matching leverages both self-attention and cross attention mechanisms. A self-attention block can be shared across two or more branches, using the same set of weights and biases to process two sets of features in parallel (as represented by the dotted line between branches). The self-attention blocks allow each feature to communicate with every other feature in the same set, which can help to grow or build the appropriate context information. A cross-attention block also allows for communication, but this communication occurs between sets. There can then be cross-domain information propagation between the NeRF descriptor features and the query image features. The dimensionality of the feature sets can remain unchanged during the coarse matching process. In at least one embodiment, cost matching can be performed based in part on the similarity comparison for every input feature vector. The output of the coarse matching process essentially indicates the image map to which the 3D points correspond, such as where every pixel in a feature map represents every 8×8 local patch in the query image. Coarse matching effectively provides the index of the pixel in the NeRF descriptor that corresponds to a given pixel in the image descriptor, but in the lower resolution (e.g., the resolution that is downscaled 8 times).

Features for the set of coarse matches 222, as well as the high resolution features 220 from the query image, can be provided as input to a feature sampling module 224, which can output sampled NeRF descriptors 226 and sampled query image features 228. In at least one embodiment, a feature sampling module 224 at this stage can take the indices of the coarse matches, which correspond to specific image patches, and find the corresponding higher resolution feature locations in the higher resolution feature map. The sampled NeRF descriptors 226 and sampled query image features 228 can be provided as input to a fine matching module 230 (or network or process, etc.) that can generate a set of fine matches 232. In at least one embodiment, NeRF-based matching can be used to match the sampled query features 228 against the sampled NeRF descriptors 226 to establish 2D-3D correspondences that can be used to determine the camera pose of the query image. For every pose of the set of coarse matches, there may be a large number (e.g., thousands) of points that are uniformly sampled on the image grid, and then their corresponding feature descriptors are obtained. For the top (e.g., 10) retrieval reference images, the descriptors can be merged before sampling or the network can be run 10 times to obtain ten sets of matches that can be provided to determine query image camera pose. Running the network multiple times without first merging the data may produce more accurate results, but also can take significantly more time and resources in at least one embodiment.

In this example, the determined fine matches can be input to a solver, such as a perspective-n-point solver 234, to output determined camera pose information for the query image 202. A PnP solver can also take as input a set of 3D points from the NeRF 204 for the environment, where those points are produced during the NeRF descriptor rendering process. A NeRF-based matching process can thus take, as inputs, the query image and the 3D points with associated NeRF descriptors rendered at the retrieved reference pose. The outputs can then correspond to the estimated 2D-3D matches between them. A final task can involve feeding the estimated 2D-3D correspondences into a solver, such as a PnP solver 234, to compute the absolute camera pose of the query image.

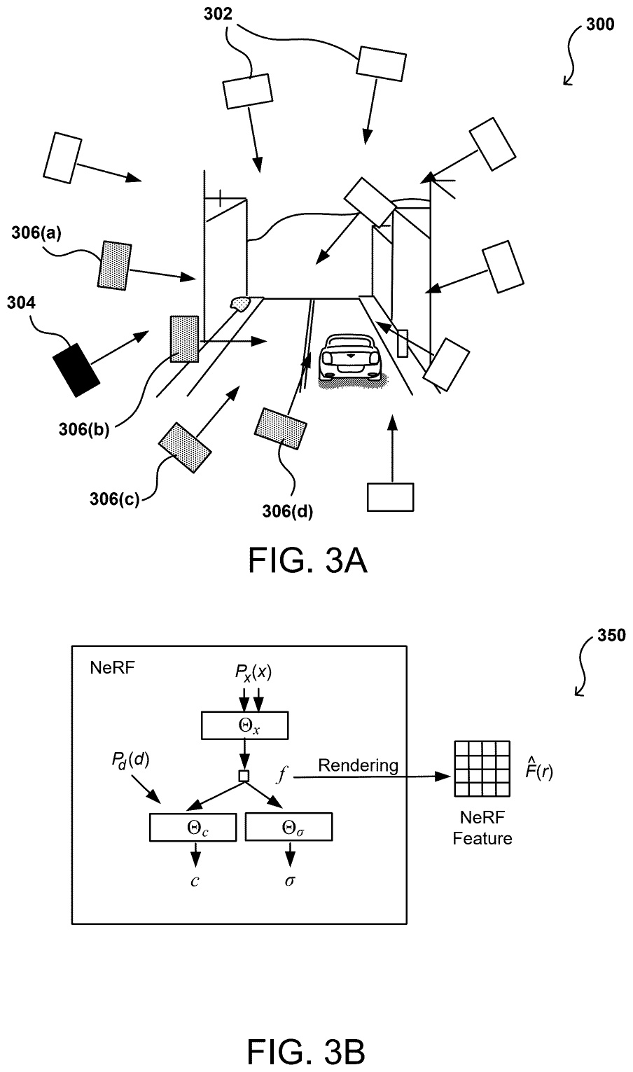

FIG. 3A illustrates an example approach 300 to narrowing the search space using a system such as that described with respect to FIG. 2. In this example, there are a number of 2D images 302 captured with different views of a 3D environment, with different camera poses (e.g., different position, orientation, and/or camera parameters). A representation of the 3D environment can be generated, such as by using these 2D images 302 to train a NeRF. A query image 304 might be received that is different from all the initial training images 302. As illustrated in FIG. 3A, however, the camera pose for the query image 304 will be most similar to a subset of the training images 302, here including a selected subset 306(a)-(d) of the training images. The pose information for the query image 304 will be more similar to the pose information for these coarsely matched images 306(a)-(d) than for the other 2D training images 302, so the pose search space can be limited to a region in 3D space that is within a given distance of these selected similar training images 306(a)-(d). For large, complex environments that may have had hundreds of high resolution training images or more, the ability to narrow the search space down to around 3-5 training images (or a similar subset) can provide for the same level of accuracy but with much less storage and data processing required. An appropriate distance metric may be used, such as a cosine similarity in feature space, where the features can be extracted using, for example, a CNN trained for image retrieval. The potential matches can be sorted or ranked by distance, for example, and a number of top (e.g., closest in feature space) coarse matches can be selected based in part on the calculated distance values. In one embodiment, the top 10 closest matches can be selected as coarse matches.

FIG. 3B illustrates example NeRF features 350 that can be extracted from a pre-trained NeRF model for a scene (e.g., a 3D or 4D scene). In some embodiments, the branch used to regress X′ can be removed or deleted from consideration. Specifically, a NeRF can map a 3D point and a camera viewing direction to the volume density and color (e.g., RGB color) of that point. This representation can be learned using a volumetric rendering procedure. As illustrated in FIG. 3B, a NeRF model can consist of two non-trainable positional encodings: Pₓ for 3D points and P_{d} for viewing directions. A NeRF model can also include at least three trainable components: a 3D point encoder Θₓ, a volume density decoder Θ_{σ}, and a color decoder Θ_{c}. Input can consist of scene coordinates X and ray directions d, and outputs can include values such as color c, density σ, and the additional prediction of input coordinates X′. Following the training phase, intermediate features, denoted as f, can be obtained using volumetric rendering or another such process. Given a 3D point in a scene, for example, with coordinates X∈R³, the coordinates can be positionally embedded and then input into the 3D encoder to obtain a 3D feature, as may be given by: f=Θₓ(Pₓ(X)). The 3D feature can then be input into the density decoder to directly predict the volume density σ=Θ_{σ}(f), while the color decoder can take a positional-embedded viewing direction d∈R² in addition to the 3D feature to compute the view-dependent color c=Θ_{c}(f, P_{d}(d)).

A NeRF can employ a continuous scene representation to render (e.g., per-ray) color using a discretized volumetric rendering procedure. For example, given a ray r(t)=o+td emitted from the camera center o∈R³, along a viewing direction d which intersects the image plane at pixel x, this ray can be evenly sampled into N 3D points between a near plane and far planes. The RGB color Ĉ(r) at pixel x can be calculated as may be given by:

$$\hat{C} ( r ) = {\sum }_{i = 1}^{N} {w}_{i} {c}_{i}$$

$${w}_{i} = {T}_{i} ( 1 - {e}^{- {δ}_{i} {σ}_{i}} )$$

where δ=tᵢ₊₁−tᵢ is the sampling interval, cᵢ and σᵢ are the predicted color and density of the i^{th} sampled 3D point, and:

$${T}_{i} = {e}^{( - {\sum }_{j = 1}^{i - 1} {σ}_{j} {δ}_{j} )}$$

A NeRF can serve as a readily-usable scene representation for visual localization, providing various advantages over prior approaches. For example, a NeRF can encode both scene appearance and geometry within a compact neural network, making it more storage efficient compared to other common representations such as image databases or 3D point clouds. A NeRF can support view rendering of scene images from various camera poses, which can be beneficial for hierarchical and iterative localization strategies. Further, a NeRF can support range rendering, which can provide 3D points of rendered views, compatible with existing localization methods reliant on 2D-3D correspondences. By allowing both appearance and geometry rendering, the learned representation becomes highly interpretable, which contrasts with other implicit scene representations for localization, such as scene coordinate regression (SCR) or absolute pose regression (APR) networks. One or more embodiments may implement an additional head to the architecture of the model to support one or more of these networks.

A NeRF can also be used in feature extraction to provide descriptors of 3D (surface) points to establish 2D-3D matches against a query image. Following a volumetric rendering process such as that described above, a rendered 3D (surface) point \hat{X}(r) can be defined, along with its associated NeRF descriptor F(r) along the ray r cast through image pixel x as the weighted sum of sampled 3D points and their respective features, as may be given by:

$$\hat{X} ( r ) = {\sum }_{i = 1}^{N} {w}_{i} {X}_{i}$$

$$\hat{F} ( r ) = {\sum }_{i = 1}^{N} {w}_{i} {f}_{i}$$

Here, Xᵢ corresponds to the i^{th} sampled 3D points, fᵢ is its 3D feature, and wᵢ is the corresponding weight computed from its volume density prediction, as discussed above. For efficiency, it may not be necessary to render 3D surface points for every pixel in one or more embodiments. Instead, rendering may be performed at the center pixels of evenly distributed image patches, such as 8×8 pixel image patches.

In at least one embodiment, an image-to-NeRF matching network can be used that allows for establishing 2D-3D correspondences between a query image and NeRF scene points for localization. Given a query image I∈ [symbol] ^{H×W} and its reference pose obtained using image retrieval, a set of 3D points Xₛ∈ [symbol] ^{N}^{ₛ}^{×3} and their associating NeRF features Fₛ∈ [symbol] ^{N}^{ₛ}^{×D}^{^{c}} can be rendered as discussed above. An example NeRF-based matching process can take in the query image and the raw NeRF features and use two encoding branches to initially process the input image and features. A coarse-to-fine paradigm of image-to-image feature matching can be followed, such as by identifying 3D-to-image patch matches using a coarse matching module, then refining to pixel accuracy with a fine matching module.

In at least one embodiment, a query image can be processed using a CNN encoder to extract image local features. A coarse-level feature map can be extracted, as may be given by:

$${F}_{m}^{c} ∈ {ℝ}^{{N}_{m} \times {D}^{c}}$$

$$with$$

$${N}_{m} = \frac{H}{8} \times \frac{W}{8}$$

and a fine-level feature map as may be given by:

$${F}_{m}^{f} ∈ {ℝ}^{\frac{H}{2} \times \frac{W}{2} \times {D}^{f}}$$

In order to make the matching module memory manageable, an approach in accordance with at least one embodiment can consider only those NeRF features Fₛ∈ [symbol] ^{N}^{ₛ}^{×D}^{^{c}} rendered along rays originated at center pixels of every 8×8 image patches in the reference view, such as may be given by:

$${N}_{s} = \frac{H}{8} \times \frac{W}{8}$$

Different from the CNN encoder that provides hierarchical image features, such as for fine-to-coarse features in resolution, NeRF features can be rendered per-ray, with each feature vector corresponding to an individual 3D point.

Coarse image features Fₘ^{c} can be determined or extracted that represent image local patches, as well as raw NeRF features Fₛ that represent individual 3D scene points. Positional information can be added via positional encoding for both sets of features before applying global attention operations. For the image features, a 2D extension of a positional encoding algorithm can be used. While NeRF features are naturally spatially-aware as being encoded from 3D points, the precise 3D information has been processed towards predicting density and color values after NeRF training. In order to improve performance, the 3D information can be explicitly enhanced by concatenating each raw NeRF feature with its positional-encoded 3D points. The global contextual information within each domain can be enriched by applying a number of self-attention blocks. The self-attention weights can be shared between images and NeRF features to help bring the features from two different domains into a common embedding space for matching. Afterwards, those features can be fed into a cross-attention layer to enable cross-domain interactions. Pair-wise cosine similarities can be computed, followed by performance of a dual-SoftMax operation to obtain a matching score matrix, as may be given by:

$$S ∈ {ℝ}^{{N}_{m} \times {N}_{s}}$$

Mutual matches can then be extracted based in part on the association scores, which can provide predicted coarse matches as may be given by:

$${ℳ}_{c} = \{ ( i , j ) \vert i ∈ ( 0 , {N}_{m} - 1 ) , j ∈ ( 0 , {N}_{s} - 1 ) \}$$

where i, j are the indices of the image and point features.

For each coarse match m_{c}=(i, j) that is extracted, a corresponding high-resolution image patch feature Fₘ^{f}(i)∈ [symbol] ^{w×w×D}^{^{f}} can be obtained from the fine-level feature map, centered around the corresponding location of the match. Inside each of these image patches, a self-attention block can be applied to spread contextual information throughout the patch. For individual 3D point features, the cross-attended feature obtained from the coarse matching can be processed through a linear layer to adjust its feature dimension from D^{c} to D^{f}. The 3D features can then each be aligned with the corresponding local feature map. Such an alignment can produce a heatmap that depicts the likelihood of the 3D point j matching with each pixel in the vicinity of image pixel i. The expected value across the probability distribution of the heat map can be computed in order to obtain the exact, fine match. The refined matches obtained through this process can be denoted as M_{f}.

The rendered 3D scene points Xₛ can be projected onto the query image using the ground-truth query camera calibration parameters, which gives their precise 2D projections xₛ at the resolution in which the fine matches are to be supervised. To compute the ground-truth coarse association matrix M_{gt} (a binary mask) for each 3D point j, it can be assigned to its belonging i^{th} 8×8 local patch in the query image. The association value can be set as M_{gt} (i, j)=1 if a 3D point j finds its 2D patch i within the query image boundary. In at least one embodiment, one image patch can be assigned to multiple 3D points even though each 3D point has at most one 2D match.

In order to properly supervise the coarse matching, a log loss can be applied to increase the dual-SoftMax probability at the ground-truth matching locations in M_{gt}. The coarse matching loss L_{c} can be given by:

$${L}_{c} = - \frac{1}{{M}_{gt}} {\sum }_{( i , j ) ∈ {M}_{gt}} log ( S ( i , j ) )$$

To compute the fine matching loss for a 3D point Xⱼ with ground-truth fine match xⱼ, the predicted fine match \tilde{x}ⱼ can be supervised by minimizing its pixel distance to the ground-truth match. The total variance σ²(j) of the corresponding heatmap can be computed, and the weighted loss function minimized as may be given by:

$${L}_{f} = \frac{1}{{M}_{f}} {\sum }_{( i , j ) ∈ {M}_{f}} \frac{1}{{σ}^{2} ( i )} {‖ {\tilde{x}}_{j} - {x}_{j} ‖}_{2}$$

The total loss can then be given as the sum of the coarse and fine matching losses L=L_{c}+L_{f}.

In one or more embodiments, NeRF features are sufficiently discriminative for use in the performance of at least some operations. In one example, direct NeRF-to-NeRF feature matching may be performed in a controlled setting. In at least one embodiment, a ground-truth camera pose of a query image may be used, along with its top retrieved reference pose. The corresponding 3D points and NeRF descriptors are then rendered, with the cosine similarities then being computed between the two sets of NeRF features (i.e., query and reference features). The matched indices that are mutually consistent from both matching directions can then be extracted. Those indices can provide the 3D-3D matches from which the 2D-3D correspondences between the query image pixels and the reference 3D points can be computed. The camera pose of the query can be computed based in part on this result. Various NeRF models can be used for such applications, as may include a “vanilla” model or a Mip-NeRF model, which extends a NeRF to sample points within conical frustums instead of along a ray. An appearance code significantly improves matching performance due to increased invariance to changes in illumination. In at least one embodiment a model such as a Mip-NeRF can be set with an appearance code and SCR supervision as a primary NeRF model for scene representation. To fully take advantage of the view synthesis ability of a NeRF, a NeRF can be used for iterative pose refinement during inference. Specifically, the predicted pose from one iteration can be used as the input reference pose for the subsequent iteration, providing an opportunity to refine pose accuracy iteratively. One or more embodiments may include at least one refinement stage for a model, such that an example default inference approach would be to always include one iteration of pose refinement following an initial prediction.

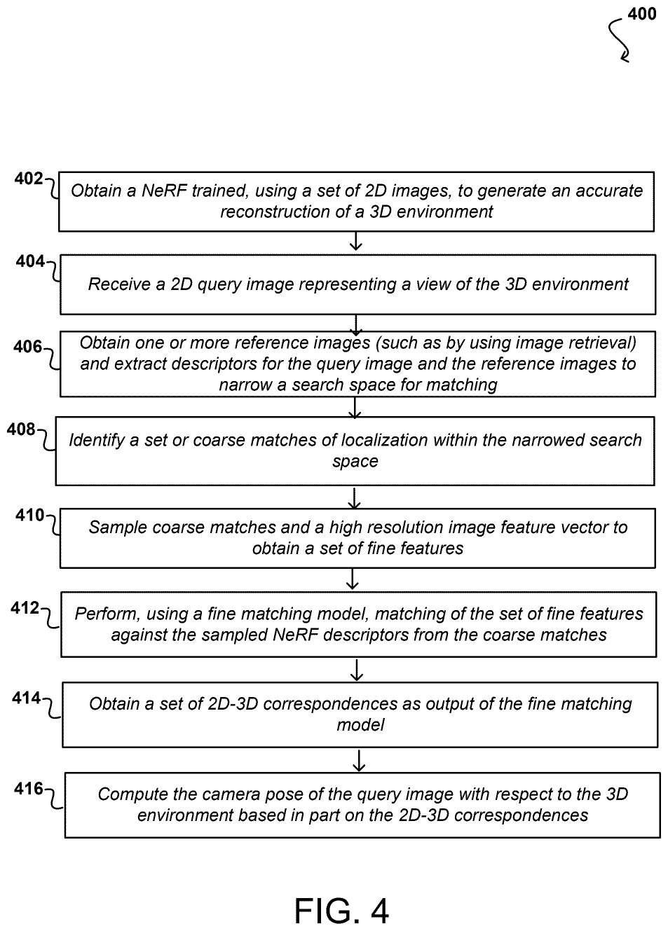

FIG. 4 illustrates an example process 400 that can be performed to determine the camera pose for a query image with respect to a representation of a 3D environment, according to at least one embodiment. It should be understood that for these and other processes presented herein there may be additional, fewer, or alternative steps performed in similar or alternative orders, or at least partially in parallel, within the scope of the various embodiments unless otherwise specifically stated. Further, although this example will be discussed with respect to NeRF models and other specific components or processes, there can be other types of models, networks, components, or processes used, as well as other types of data or content, within the scope of various embodiments. In the example process 400 illustrated in FIG. 4, a trained NeRF can be obtained 402 that was trained to generate an accurate reconstruction of a 3D environment. As mentioned, the NeRF can have been trained using at least a set of 2D images of the environment, where at least some of the images represent different camera poses. A 2D query image can be received 404 that represents a view of the 3D environment. Other types of queries may be received as well that correspond to specific camera poses. It can be desired to determine the camera pose data for the query image with respect to the 3D environment. One or more reference images can be obtained 406, such as by using image retrieval or through synthetic generation, and global descriptors extracted for the query image and the reference image(s). Lower resolution and higher resolution image features can be extracted, such as by extracting from multiple layers from a CNN encoder. Distances between the extracted features can be compared in order to narrow a search space. A set of coarse matches for localization can be identified 408 within this narrow search space. Features for the coarse matches and the high resolution image feature vector can be sampled 410 to obtain a set of fine features that can be used for fine matching. A fine matching model can be used to perform 412 the matching of the set of fine features against the sampled NeRF descriptors identified from the coarse matches. A set of 2D-3D correspondences can be obtained 414 as output of the fine matching model or process. The camera pose of the query image can then be computed 416 with respect to the 3D environment based in part on the 2D-3D correspondences.

In at least one embodiment, a trained NeRF can be used to generate images of a scene from any appropriate view, which may include one or more novel views that were not represented in the training data used to train the NeRF. In an autonomous driving domain, for example, it might be desirable to generate image content for views that might differ based on a type of vehicle. For example, training data may have been obtained using cameras on a sedan that might be approximately two to five feet above street level. If image data is to be generated that is to be used for testing an autonomous driving system for a semi-tractor-trailer, however, the cameras on that vehicle might be in a very different location, such as may be eight to ten feet above street level for certain taller vehicles. If image data is to be generated that is to be used to test, validate, or provide a simulation environment for an unmanned aerial vehicle, for example, then the view distance above street level could be significantly higher. A training approach as presented herein enables the NeRF to generate high quality image data for a particular 3D scene while allowing for random placement of a virtual camera to anywhere within, or proximate, that scene. The size of a scene to be represented can vary, and in some instances a set of NeRFs can be used to generate image data for a 3D environment that can be stitched together or otherwise used to serve as a digital reconstruction of that environment. Once a NeRF is an expert on a scene, the NeRF can be provided with a location and orientation of a virtual camera and can render an image of the scene without any input image or other such data, in at least one embodiment.

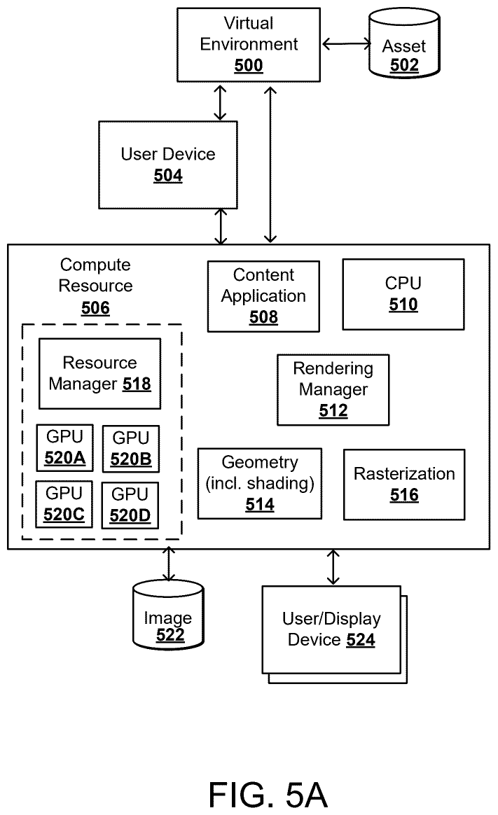

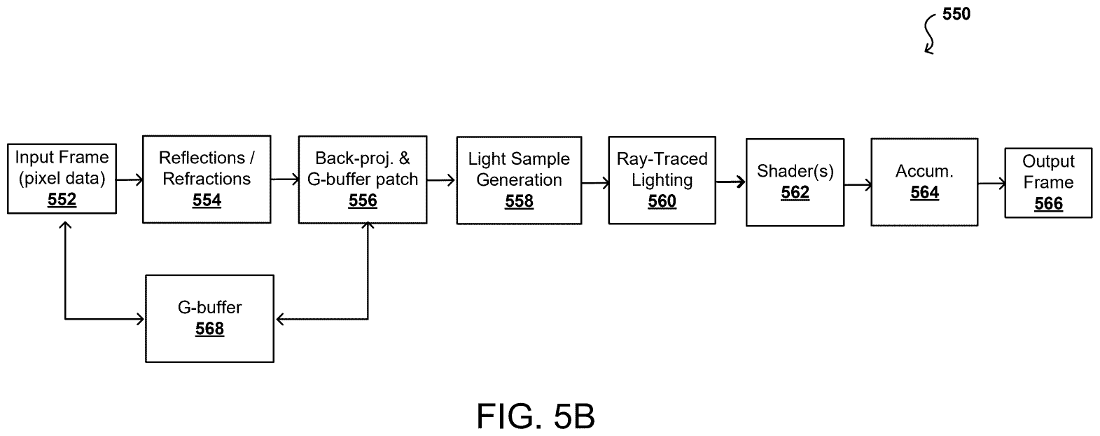

As mentioned, a NeRF can represent a model of a complex 3D environment, and can be used to generate 2D images (or other views or representations) of the environment. If only pose information is stored for the 2D images used to train a NeRF, a rendering process can be used to generate a reconstruction of those images from the respective poses. FIG. 5A illustrates an example system 500 for rendering an image, video frame, or other instance of image-related content in accordance with at least one embodiment. Such a system can include or incorporate functionality as presented herein to allow for the generation of content from various sources, such as may be generated using one or more NeRF-based models, among other such options. In this example, an image is to be rendered for a scene in a virtual environment 500, although images can be rendered for semi-virtual or real environments as well using such a system. The virtual environment 500 may include geometry and other data representative of shapes or objects in the environment, such as three-dimensional (3D) objects that are representative, or are to be included in, a scene that occurs within the environment, as may include foreground objects such as people or vehicles, or background objects such as roads and buildings, among other such options. In at least some embodiments, at least some of the content for the scene may also be obtained from an asset repository 502, or other such location, which can contain content—such as geometry, textures, and density data—that can be used to render the scene. In at least some embodiments or instances, there can be a user device 504 running a content generation or management application that can allow a user to select assets 502 and at least a relevant portion of the virtual environment 500 to use in rendering the scene. The user device 504 can also allow a user to control aspects of the image to be rendered, such as the location or pose of an object in the scene, as well as a viewpoint and other parameters of a virtual camera to be used to render an image of the virtual environment 500.

In this example, at least one compute resource 506 is used to perform the rendering. This resource may correspond to one or more servers, for example, that may be located locally or across at least one network, among other such options. In some embodiments, the rendering may instead be at least partially performed on the user device 504. The compute resource 506 may obtain or receive data to be used for the rendering, as may include geometry, texture, and density data for the virtual environment or assets, as well as information about the locations and poses of those objects in the scene and parameters of a virtual camera to be used to determine the view of the scene to be rendered. This information may be received to a content application 508, for example, that may be executing on a central processing unit (CPU) 510 of the compute resource that is responsible for tasks such as collecting data, causing an image to be rendered, and performing any formatting or encoding of a produced image, among other such operations. The content application can work with a rendering manager 512, for example, which can be responsible for coordinating operations of a rendering pipeline executing on the compute resource 506, as may include modules 514, 516 or processes responsible for tasks such as geometry related tasks (including lighting and shading tasks) and rasterization, among other such tasks. In at least one embodiment, a rendering manager 512 can use at least one NeRF-based model as discussed herein to generate a digital reconstruction of the virtual environment 500. In at least some embodiments, at least some of these rendering tasks may be performed using one or more GPUs 520A-D of the compute resource, as well as potentially one or more processors or compute instances (physical or virtual) of one or more other compute resources.

A task such as light transport simulation (e.g., ray tracing, path tracing, ray marching, etc.) or volumetric sampling can be performed using a single processor, such as a single GPU, or can have operations distributed across multiple GPUs 520A-D). In this example, there can be a pool or set of GPUs 520A-D, and a resource manager 518 can be at least partially responsible for allocating a GPU to perform the processing for an operation. If it is desired or beneficial to use more than one GPU then the resource manager 518 can allocate one or more GPUs having the appropriate capacity or capabilities. This can include allocating a number of GPUs indicated in a request, or determining a number of GPUs to allocate based in part on the request. In some embodiments, the resource manager may also be able to monitor an available bandwidth or memory in order to determine which and how many GPUs to allocate, such as where having high bandwidth capacity can allow operations to be spread across a greater number of GPUs, where bandwidth impact due to forwarding ray information will not be as critical, while having a bandwidth constrained system may cause the resource manager to attempt to allocate as few GPUs as possible in order to attempt to reduce the number of forwarding messages required.

In at least one embodiment, a partitioning of data can be performed by a rendering manager 512, for example, and the assigning of data to different processors can be performed by a resource manager 518 of the system. The resource manager can receive information from the rendering component, and can select appropriate processors from a pool of available processors 520 or processor capacity. In some embodiments, the rendering application can choose the partitioning, while in other embodiments the renderer may have no control over the data partitioning, which may be done by a separate management component (not illustrated in FIG. 5A).

FIG. 5B illustrates an example image generation pipeline 550 that can be used in a system 500—such as that illustrated in FIG. 5A—to render one or more images, such as video frames in a sequence for a specific scene and/or domain. In this example, pixel data 552 for a current frame to be rendered (as may include G-buffer data for primary surfaces) can be received as input to a reflections and refractions component 554 of a rendering system. Reflections and refractions component 554 can use this data to attempt to determine data for any determined reflections and/or refractions in the pixel data, and can provide this data to a back-projection and G-buffer patching component 556, which can perform back-propagation as discussed herein to locate corresponding points for those reflections and refractions, and use this data to patch the G-buffer 568, which can provide updated input for a subsequent frame to be rendered. The data can then be provided to a light sample generation component 558 to perform light sampling, a ray-traced lighting component 560 to perform ray-traced lighting, and one or more shaders 562, which can set the pixel colors for the various pixels of the frame based at least in part upon the determined lighting information (along with other information such as color, texture, and so on). The results can be accumulated by an accumulation module 564 or component for generating an output frame 566 of a desired size, resolution, or format.

In at least one embodiment, a shader 558 can perform the backward projection step. Once a backward projection pass has finished, and gradient surface parameters have been patched into the current G-buffer, a renderer can execute the lighting passes. Using information from the lighting passes and the lighting results from the previous frame, gradients can be computed then filtered and used for history rejection. Such an approach can be used to compute robust temporal gradients between current and previous frames in a temporal denoiser for ray traced renderers. Such a backward projection-based approach can also work through reflections and refractions, and can work with rasterized G-buffers. Previous approaches for backward projection omitted any G-buffer patching and relied on the raw current G-buffer samples instead, which also results in false positive gradients. Patching the surface parameters can eliminate false positives in the vast majority of cases, making the denoised image very stable yet still quickly reacting to lighting changes. Once the backward projection pass is finished, and gradient surface parameters have been patched into the current G-buffer, a renderer can execute the lighting passes. Using the information from the lighting passes and the lighting results from the previous frame, the gradients are computed then filtered and used for history rejection. NeRFs or other machine learning models can be used at various stages of such a pipeline, for use in inferring aspects of the rendering process.

Aspects of various approaches presented herein can be lightweight enough to execute in various locations, such as on a device such as a client device that include a personal computer or gaming console, in real time. Such processing can be performed on, or for, content that is generated on, or received by, that client device or received from an external source, such as streaming data or other content received over at least one network from a cloud server 620 or third party service 660, among other such options. In some instances, at least a portion of the processing, generation, compositing, and/or determination of this content may be performed by one of these other devices, systems, or entities, then provided to the client device (or another such recipient) for presentation or another such use.

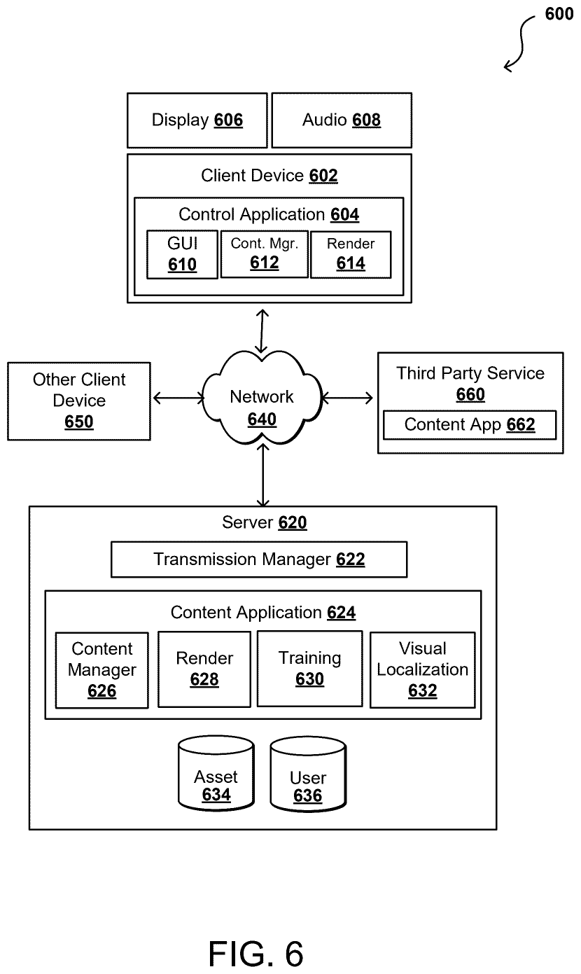

As an example, FIG. 6 illustrates an example network configuration 600 that can be used to provide, generate, modify, encode, process, and/or transmit image data or other such content. In at least one embodiment, a client device 602 can generate or receive data for a session using components of a content application 604 on client device 602 and data stored locally on that client device. In at least one embodiment, a content application 624 executing on a server 620 (e.g., a cloud server or edge server) may initiate a session associated with at least one client device 602, as may utilize a session manager and user data stored in a user database 636, and can cause content such as one or more digital assets (e.g., implicit and/or explicit object representations) from an asset repository 634 to be determined by a content manager 626. A content manager 626 may work with a rendering module 628 to generate or select objects, digital assets, or other such content to be placed in a virtual environment and allowed to move or act within that environment. Views of these objects can be rendered by the rendering module 628 and provided for presentation via the client device 602. In at least one embodiment, this rendering module 628 can work with a training module 630 that can train one or more generative networks, such as a NeRF or diffusion model, to generate content, where those models can be trained or fine-tuned for specific scenes, domains, or other such aspects. As discussed herein, a visual localization module 6320 or process can be used to perform localization using a NeRF representation of a scene or environment, along with a received query image. If the NeRF training images are not cached, then the rendering module 628 can be used to reconstruct the appropriate training images using cached pose information. At least a portion of the rendered and composited (or otherwise generated or selected) content may be transmitted to the client device 602 using an appropriate transmission manager 622 to send by download, streaming, or another such transmission channel. An encoder may be used to encode and/or compress at least some of this data before transmitting to the client device 602. In at least one embodiment, the client device 602 receiving such content can provide this content to a corresponding content application 604, which may also or alternatively include a graphical user interface 610, content manager 612, and rendering module 614 for use in providing, synthesizing, rendering, compositing, modifying, or using content for presentation (or other purposes) on or by the client device 602. A decoder may also be used to decode data received over the network(s) 640 for presentation via client device 602, such as image or video content through a display 606 and audio, such as sounds and music, through at least one audio playback device 608, such as speakers or headphones. In at least one embodiment, at least some of this content may already be stored on, rendered on, or accessible to client device 602 such that transmission over network 640 is not required for at least that portion of content, such as where that content may have been previously downloaded or stored locally on a hard drive or optical disk. In at least one embodiment, a transmission mechanism such as data streaming can be used to transfer this content from server 620, or user database 636, to client device 602. In at least one embodiment, at least a portion of this content can be obtained, enhanced, and/or streamed from another source, such as a third party service 660 or other client device 650, that may also include a content application 662 for generating, enhancing, or providing content. In at least one embodiment, portions of this functionality can be performed using multiple computing devices, or multiple processors within one or more computing devices, such as may include a combination of CPUs and GPUs.

In this example, these client devices can include any appropriate computing devices, as may include a desktop computer, notebook computer, set-top box, streaming device, gaming console, smartphone, tablet computer, VR headset, AR goggles, wearable computer, or a smart television. Each client device can submit a request across at least one wired or wireless network, as may include the Internet, an Ethernet, a local area network (LAN), or a cellular network, among other such options. In this example, these requests can be submitted to an address associated with a cloud provider, who may operate or control one or more electronic resources in a cloud provider environment, such as may include a data center or server farm. In at least one embodiment, the request may be received or processed by at least one edge server, that sits on a network edge and is outside at least one security layer associated with the cloud provider environment. In this way, latency can be reduced by enabling the client devices to interact with servers that are in closer proximity, while also improving security of resources in the cloud provider environment.

In at least one embodiment, such a system can be used for performing graphical rendering operations. In other embodiments, such a system can be used for other purposes, such as for providing image or video content to test or validate autonomous machine applications, or for performing deep learning operations. In at least one embodiment, such a system can be implemented using an edge device, or may incorporate one or more Virtual Machines (VMs). In at least one embodiment, such a system can be implemented at least partially in a data center or at least partially using cloud computing resources.

### Inference and Training Logic

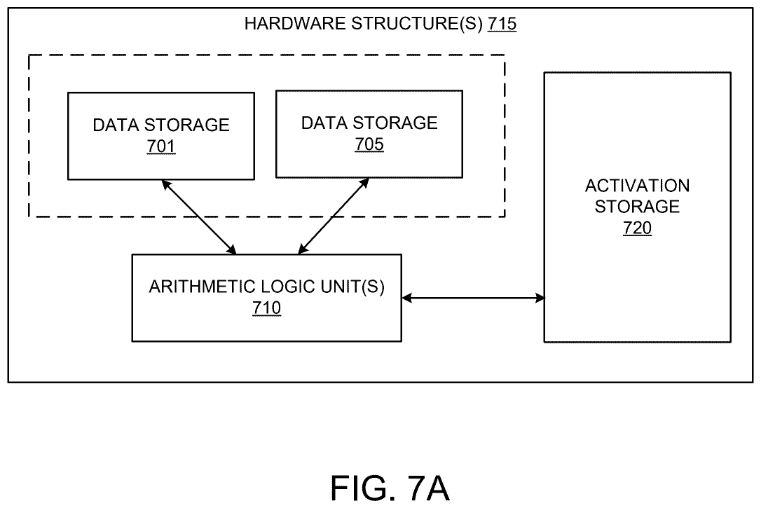

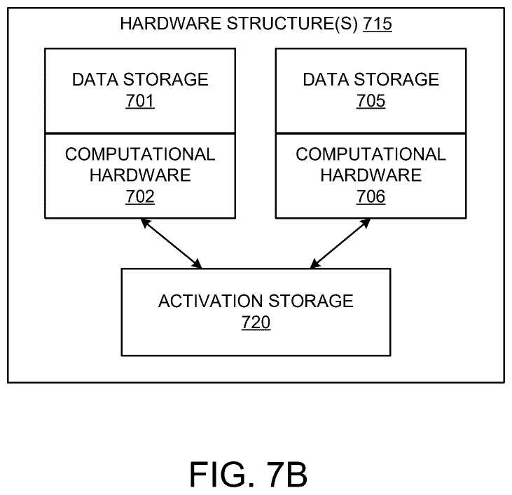

FIG. 7A illustrates inference and/or training logic 715 used to perform inferencing and/or training operations associated with one or more embodiments. Details regarding inference and/or training logic 715 are provided below in conjunction with FIGS. 7A and/or 7B.

In at least one embodiment, inference and/or training logic 715 may include, without limitation, code and/or data storage 701 to store forward and/or output weight and/or input/output data, and/or other parameters to configure neurons or layers of a neural network trained and/or used for inferencing in aspects of one or more embodiments. In at least one embodiment, training logic 715 may include, or be coupled to code and/or data storage 701 to store graph code or other software to control timing and/or order, in which weight and/or other parameter information is to be loaded to configure, logic, including integer and/or floating point units (collectively, arithmetic logic units (ALUs). In at least one embodiment, code, such as graph code, loads weight or other parameter information into processor ALUs based on an architecture of a neural network to which the code corresponds. In at least one embodiment, code and/or data storage 701 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 701 may be included with other on-chip or off-chip data storage, including a processor's L1, L2, or L3 cache or system memory.

In at least one embodiment, any portion of code and/or data storage 701 may be internal or external to one or more processors or other hardware logic devices or circuits. In at least one embodiment, code and/or data storage 701 may be cache memory, dynamic randomly addressable memory (“DRAM”), static randomly addressable memory (“SRAM”), non-volatile memory (e.g., Flash memory), or other storage. In at least one embodiment, choice of whether code and/or data storage 701 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 may include, without limitation, a code and/or data storage 705 to store backward and/or output weight and/or input/output data corresponding to neurons or layers of a neural network trained and/or used for inferencing in aspects of one or more embodiments. In at least one embodiment, code and/or data storage 705 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 715 may include, or be coupled to code and/or data storage 705 to store graph code or other software to control timing and/or order, in which weight and/or other parameter information is to be loaded to configure, logic, including integer and/or floating point units (collectively, arithmetic logic units (ALUs). In at least one embodiment, code, such as graph code, loads weight or other parameter information into processor ALUs based on an architecture of a neural network to which the code corresponds. In at least one embodiment, any portion of code and/or data storage 705 may be included with other on-chip or off-chip data storage, including a processor's L1, L2, or L3 cache or system memory. In at least one embodiment, any portion of code and/or data storage 705 may be internal or external to one or more processors or other hardware logic devices or circuits. In at least one embodiment, code and/or data storage 705 may be cache memory, DRAM, SRAM, non-volatile memory (e.g., Flash memory), or other storage. In at least one embodiment, choice of whether code and/or data storage 705 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage 701 and code and/or data storage 705 may be separate storage structures. In at least one embodiment, code and/or data storage 701 and code and/or data storage 705 may be same storage structure. In at least one embodiment, code and/or data storage 701 and code and/or data storage 705 may be partially same storage structure and partially separate storage structures. In at least one embodiment, any portion of code and/or data storage 701 and code and/or data storage 705 may be included with other on-chip or off-chip data storage, including a processor's L1, L2, or L3 cache or system memory.

In at least one embodiment, inference and/or training logic 715 may include, without limitation, one or more arithmetic logic unit(s) (“ALU(s)”) 710, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 720 that are functions of input/output and/or weight parameter data stored in code and/or data storage 701 and/or code and/or data storage 705. In at least one embodiment, activations stored in activation storage 720 are generated according to linear algebraic and or matrix-based mathematics performed by ALU(s) 710 in response to performing instructions or other code, wherein weight values stored in code and/or data storage 705 and/or code and/or data storage 701 are used as operands along with other values, such as bias values, gradient information, momentum values, or other parameters or hyperparameters, any or all of which may be stored in code and/or data storage 705 or code and/or data storage 701 or another storage on or off-chip.

In at least one embodiment, ALU(s) 710 are included within one or more processors or other hardware logic devices or circuits, whereas in another embodiment, ALU(s) 710 may be external to a processor or other hardware logic device or circuit that uses them (e.g., a co-processor). In at least one embodiment, ALU(s) 710 may be included within a processor's execution units or otherwise within a bank of ALUs accessible by a processor's execution units either within same processor or distributed between different processors of different types (e.g., central processing units, graphics processing units, fixed function units, etc.). In at least one embodiment, code and/or data storage 701, code and/or data storage 705, and activation storage 720 may be on same processor or other hardware logic device or circuit, whereas in another embodiment, they may be in different processors or other hardware logic devices or circuits, or some combination of same and different processors or other hardware logic devices or circuits. In at least one embodiment, any portion of activation storage 720 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 720 may be cache memory, DRAM, SRAM, non-volatile memory (e.g., Flash memory), or other storage. In at least one embodiment, activation storage 720 may be completely or partially within or external to one or more processors or other logical circuits. In at least one embodiment, choice of whether activation storage 720 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors. In at least one embodiment, inference and/or training logic 715 illustrated in FIG. 7A may be used in conjunction with an application-specific integrated circuit (“ASIC”), such as Tensorflow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7A may be used in conjunction with central processing unit (“CPU”) hardware, graphics processing unit (“GPU”) hardware or other hardware, such as field programmable gate arrays (“FPGAs”).

FIG. 7B illustrates inference and/or training logic 715, according to at least one or more embodiments. In at least one embodiment, inference and/or training logic 715 may include, without limitation, hardware logic in which computational resources are dedicated or otherwise exclusively used in conjunction with weight values or other information corresponding to one or more layers of neurons within a neural network. In at least one embodiment, inference and/or training logic 715 illustrated in FIG. 7B may be used in conjunction with an application-specific integrated circuit (ASIC), such as Tensorflow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7B may be used in conjunction with central processing unit (CPU) hardware, graphics processing unit (GPU) hardware or other hardware, such as field programmable gate arrays (FPGAs). In at least one embodiment, inference and/or training logic 715 includes, without limitation, code and/or data storage 701 and code and/or data storage 705, which may be used to store code (e.g., graph code), weight values and/or other information, including bias values, gradient information, momentum values, and/or other parameter or hyperparameter information. In at least one embodiment illustrated in FIG. 7B, each of code and/or data storage 701 and code and/or data storage 705 is associated with a dedicated computational resource, such as computational hardware 702 and computational hardware 706, respectively. In at least one embodiment, each of computational hardware 702 and computational hardware 706 comprises one or more ALUs that perform mathematical functions, such as linear algebraic functions, only on information stored in code and/or data storage 701 and code and/or data storage 705, respectively, result of which is stored in activation storage 720.

In at least one embodiment, each of code and/or data storage 701 and 705 and corresponding computational hardware 702 and 706, respectively, correspond to different layers of a neural network, such that resulting activation from one “storage/computational pair 701/702” of code and/or data storage 701 and computational hardware 702 is provided as an input to “storage/computational pair 705/706” of code and/or data storage 705 and computational hardware 706, in order to mirror conceptual organization of a neural network. In at least one embodiment, each of storage/computational pairs 701/702 and 705/706 may correspond to more than one neural network layer. In at least one embodiment, additional storage/computation pairs (not shown) subsequent to or in parallel with storage computation pairs 701/702 and 705/706 may be included in inference and/or training logic 715.

### Data Center

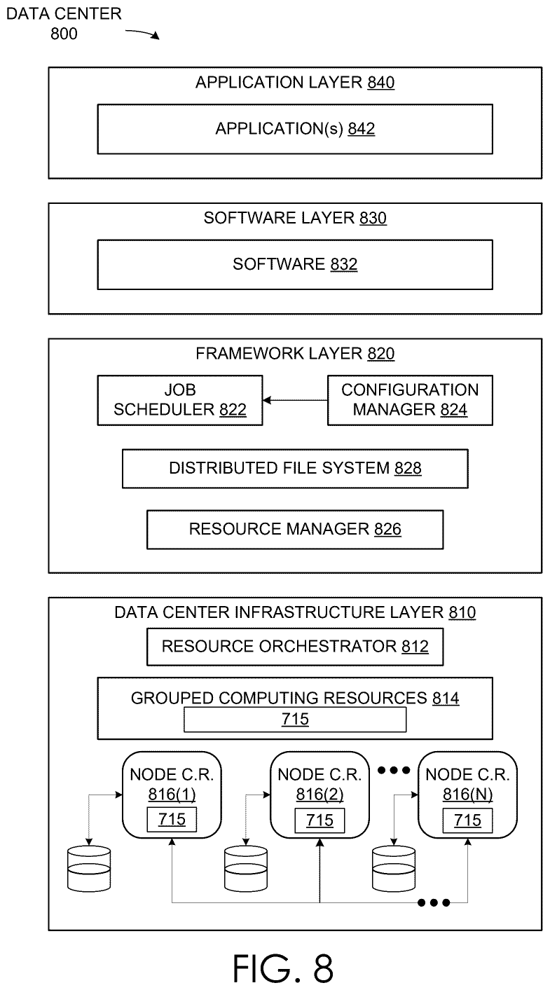

FIG. 8 illustrates an example data center 800, in which at least one embodiment may be used. In at least one embodiment, data center 800 includes a data center infrastructure layer 810, a framework layer 820, a software layer 830, and an application layer 840.

In at least one embodiment, as shown in FIG. 8, data center infrastructure layer 810 may include a resource orchestrator 812, grouped computing resources 814, and node computing resources (“node C.R.s”) 816(1)-816(N), where “N” represents any whole, positive integer. In at least one embodiment, node C.R.s 816(1)-816(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 816(1)-816(N) may be a server having one or more of above-mentioned computing resources.

In at least one embodiment, grouped computing resources 814 may include separate groupings of node C.R.s housed within one or more racks (not shown), or many racks housed in data centers at various geographical locations (also not shown). Separate groupings of node C.R.s within grouped computing resources 814 may include grouped compute, network, memory or storage resources that may be configured or allocated to support one or more workloads. In at least one embodiment, several node C.R.s including CPUs or processors may be grouped within one or more racks to provide compute resources to support one or more workloads. In at least one embodiment, one or more racks may also include any number of power modules, cooling modules, and network switches, in any combination.

In at least one embodiment, resource orchestrator 812 may configure or otherwise control one or more node C.R.s 816(1)-816(N) and/or grouped computing resources 814. In at least one embodiment, resource orchestrator 812 may include a software design infrastructure (“SDI”) management entity for data center 800. In at least one embodiment, resource orchestrator 812 may include hardware, software or some combination thereof.

In at least one embodiment, as shown in FIG. 8, framework layer 820 includes a job scheduler 822, a configuration manager 824, a resource manager 826 and a distributed file system 828. In at least one embodiment, framework layer 820 may include a framework to support software 832 of software layer 830 and/or one or more application(s) 842 of application layer 840. In at least one embodiment, software 832 or application(s) 842 may respectively include web-based service software or applications, such as those provided by Amazon Web Services, Google Cloud and Microsoft Azure. In at least one embodiment, framework layer 820 may be, but is not limited to, a type of free and open-source software web application framework such as Apache Spark™ (hereinafter “Spark”) that may use distributed file system 828 for large-scale data processing (e.g., “big data”). In at least one embodiment, job scheduler 822 may include a Spark driver to facilitate scheduling of workloads supported by various layers of data center 800. In at least one embodiment, configuration manager 824 may be capable of configuring different layers such as software layer 830 and framework layer 820 including Spark and distributed file system 828 for supporting large-scale data processing. In at least one embodiment, resource manager 826 may be capable of managing clustered or grouped computing resources mapped to or allocated for support of distributed file system 828 and job scheduler 822. In at least one embodiment, clustered or grouped computing resources may include grouped computing resource 814 at data center infrastructure layer 810. In at least one embodiment, resource manager 826 may coordinate with resource orchestrator 812 to manage these mapped or allocated computing resources.

In at least one embodiment, software 832 included in software layer 830 may include software used by at least portions of node C.R.s 816(1)-816(N), grouped computing resources 814, and/or distributed file system 828 of framework layer 820. The one or more types of software may include, but are not limited to, Internet web page search software, e-mail virus scan software, database software, and streaming video content software.

In at least one embodiment, application(s) 842 included in application layer 840 may include one or more types of applications used by at least portions of node C.R.s 816(1)-816(N), grouped computing resources 814, and/or distributed file system 828 of framework layer 820. One or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 824, resource manager 826, and resource orchestrator 812 may implement any number and type of self-modifying actions based on any amount and type of data acquired in any technically feasible fashion. In at least one embodiment, self-modifying actions may relieve a data center operator of data center 800 from making possibly bad configuration decisions and possibly avoiding underused and/or poor performing portions of a data center.

In at least one embodiment, data center 800 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 800. In at least one embodiment, trained machine learning models corresponding to one or more neural networks may be used to infer or predict information using resources described above with respect to data center 800 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 715 are used to perform inferencing and/or training operations associated with one or more embodiments. Details regarding inference and/or training logic 715 are provided below in conjunction with FIGS. 7A and/or 7B. In at least one embodiment, inference and/or training logic 715 may be used in system FIG. 8 for inferencing or predicting operations based, at least in part, on weight parameters calculated using neural network training operations, neural network functions and/or architectures, or neural network use cases described herein.

Such components can be used to perform visual localization by performing coarse matches using NeRF descriptors and query image features, then fine tuning using higher resolution features.

### Computer Systems

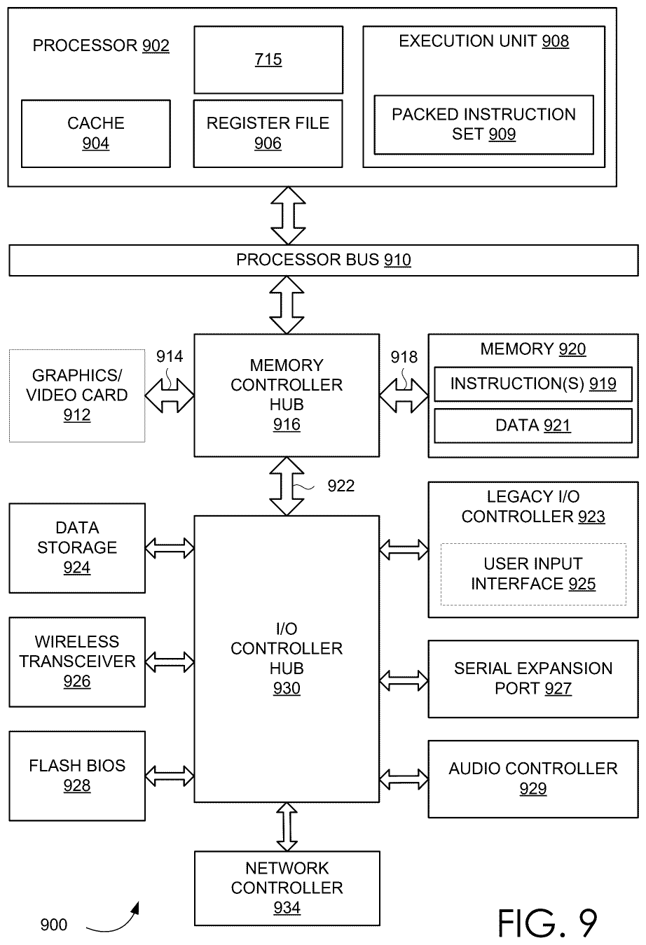

FIG. 9 is a block diagram illustrating an exemplary computer system, which may be a system with interconnected devices and components, a system-on-a-chip (SOC) or some combination thereof 900 formed with a processor that may include execution units to execute an instruction, according to at least one embodiment. In at least one embodiment, computer system 900 may include, without limitation, a component, such as a processor 902 to employ execution units including logic to perform algorithms for process data, in accordance with present disclosure, such as in embodiment described herein. In at least one embodiment, computer system 900 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 900 may execute a version of WINDOWS' operating system available from Microsoft Corporation of Redmond, Wash., although other operating systems (UNIX and Linux for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), set-top boxes, network hubs, wide area network (“WAN”) switches, or any other system that may perform one or more instructions in accordance with at least one embodiment.

In at least one embodiment, computer system 900 may include, without limitation, processor 902 that may include, without limitation, one or more execution units 908 to perform machine learning model training and/or inferencing according to techniques described herein. In at least one embodiment, computer system 900 is a single processor desktop or server system, but in another embodiment computer system 900 may be a multiprocessor system. In at least one embodiment, processor 902 may include, without limitation, a complex instruction set computing (“CISC”) microprocessor, a reduced instruction set computing (“RISC”) microprocessor, a very long instruction word (“VLIW”) computing microprocessor, a processor implementing a combination of instruction sets, or any other processor device, such as a digital signal processor, for example. In at least one embodiment, processor 902 may be coupled to a processor bus 910 that may transmit data signals between processor 902 and other components in computer system 900.

In at least one embodiment, processor 902 may include, without limitation, a Level 1 (“L1”) internal cache memory (“cache”) 904. In at least one embodiment, processor 902 may have a single internal cache or multiple levels of internal cache. In at least one embodiment, cache memory may reside external to processor 902. Other embodiments may also include a combination of both internal and external caches depending on particular implementation and needs. In at least one embodiment, register file 906 may store different types of data in various registers including, without limitation, integer registers, floating point registers, status registers, and instruction pointer register.

In at least one embodiment, execution unit 908, including, without limitation, logic to perform integer and floating point operations, also resides in processor 902. In at least one embodiment, processor 902 may also include a microcode (“ucode”) read only memory (“ROM”) that stores microcode for certain macro instructions. In at least one embodiment, execution unit 908 may include logic to handle a packed instruction set 909. In at least one embodiment, by including packed instruction set 909 in an instruction set of a general-purpose processor 902, along with associated circuitry to execute instructions, operations used by many multimedia applications may be performed using packed data in a general-purpose processor 902. In one or more embodiments, many multimedia applications may be accelerated and executed more efficiently by using full width of a processor's data bus for performing operations on packed data, which may eliminate need to transfer smaller units of data across processor's data bus to perform one or more operations one data element at a time.

In at least one embodiment, execution unit 908 may also be used in microcontrollers, embedded processors, graphics devices, DSPs, and other types of logic circuits. In at least one embodiment, computer system 900 may include, without limitation, a memory 920. In at least one embodiment, memory 920 may be implemented as a Dynamic Random Access Memory (“DRAM”) device, a Static Random Access Memory (“SRAM”) device, flash memory device, or other memory device. In at least one embodiment, memory 920 may store instruction(s) 919 and/or data 921 represented by data signals that may be executed by processor 902.

In at least one embodiment, system logic chip may be coupled to processor bus 910 and memory 920. In at least one embodiment, system logic chip may include, without limitation, a memory controller hub (“MCH”) 916, and processor 902 may communicate with MCH 916 via processor bus 910. In at least one embodiment, MCH 916 may provide a high bandwidth memory path 918 to memory 920 for instruction and data storage and for storage of graphics commands, data and textures. In at least one embodiment, MCH 916 may direct data signals between processor 902, memory 920, and other components in computer system 900 and to bridge data signals between processor bus 910, memory 920, and a system I/O 922. In at least one embodiment, system logic chip may provide a graphics port for coupling to a graphics controller. In at least one embodiment, MCH 916 may be coupled to memory 920 through a high bandwidth memory path 918 and graphics/video card 912 may be coupled to MCH 916 through an Accelerated Graphics Port (“AGP”) interconnect 914.

In at least one embodiment, computer system 900 may use system I/O 922 that is a proprietary hub interface bus to couple MCH 916 to I/O controller hub (“ICH”) 930. In at least one embodiment, ICH 930 may provide direct connections to some I/O devices via a local I/O bus. In at least one embodiment, local I/O bus may include, without limitation, a high-speed I/O bus for connecting peripherals to memory 920, chipset, and processor 902. Examples may include, without limitation, an audio controller 929, a firmware hub (“flash BIOS”) 928, a wireless transceiver 926, a data storage 924, a legacy I/O controller 923 containing user input and keyboard interfaces 925, a serial expansion port 927, such as Universal Serial Bus (“USB”), and a network controller 934. Data storage 924 may comprise a hard disk drive, a floppy disk drive, a CD-ROM device, a flash memory device, or other mass storage device.

In at least one embodiment, FIG. 9 illustrates a system, which includes interconnected hardware devices or “chips”, whereas in other embodiments, FIG. 9 may illustrate an exemplary System on a Chip (“SoC”). In at least one embodiment, devices may be interconnected with proprietary interconnects, standardized interconnects (e.g., PCIe) or some combination thereof. In at least one embodiment, one or more components of computer system 900 are interconnected using compute express link (CXL) interconnects.

Inference and/or training logic 715 are used to perform inferencing and/or training operations associated with one or more embodiments. Details regarding inference and/or training logic 715 are provided below in conjunction with FIGS. 7A and/or 7B. In at least one embodiment, inference and/or training logic 715 may be used in system FIG. 9 for inferencing or predicting operations based, at least in part, on weight parameters calculated using neural network training operations, neural network functions and/or architectures, or neural network use cases described herein.

Such components can be used to perform visual localization by performing coarse matches using NeRF descriptors and query image features, then fine tuning using higher resolution features.

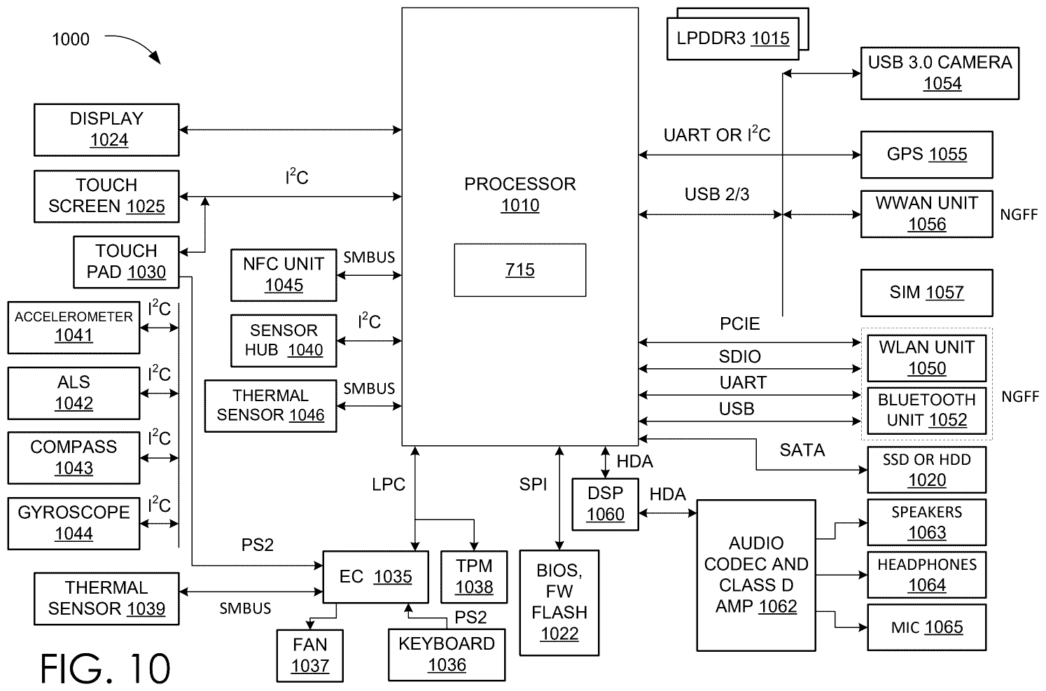

FIG. 10 is a block diagram illustrating an electronic device 1000 for utilizing a processor 1010, according to at least one embodiment. In at least one embodiment, electronic device 1000 may be, for example and without limitation, a notebook, a tower server, a rack server, a blade server, a laptop, a desktop, a tablet, a mobile device, a phone, an embedded computer, or any other suitable electronic device.

In at least one embodiment, electronic device 1000 may include, without limitation, processor 1010 communicatively coupled to any suitable number or kind of components, peripherals, modules, or devices. In at least one embodiment, processor 1010 coupled using a bus or interface, such as a 1° C. bus, a System Management Bus (“SMBus”), a Low Pin Count (LPC) bus, a Serial Peripheral Interface (“SPI”), a High Definition Audio (“HDA”) bus, a Serial Advance Technology Attachment (“SATA”) bus, a Universal Serial Bus (“USB”) (versions 1, 2, 3), or a Universal Asynchronous Receiver/Transmitter (“UART”) bus. In at least one embodiment, FIG. 10 illustrates a system, which includes interconnected hardware devices or “chips”, whereas in other embodiments, FIG. 10 may illustrate an exemplary System on a Chip (“SoC”). In at least one embodiment, devices illustrated in FIG. 10 may be interconnected with proprietary interconnects, standardized interconnects (e.g., PCIe) or some combination thereof. In at least one embodiment, one or more components of FIG. 10 are interconnected using compute express link (CXL) interconnects.

In at least one embodiment, FIG. 10 may include a display 1024, a touch screen 1025, a touch pad 1030, a Near Field Communications unit (“NFC”) 1045, a sensor hub 1040, a thermal sensor 1046, an Express Chipset (“EC”) 1035, a Trusted Platform Module (“TPM”) 1038, BIOS/firmware/flash memory (“BIOS, FW Flash”) 1022, a DSP 1060, a drive 1020 such as a Solid State Disk (“SSD”) or a Hard Disk Drive (“HDD”), a wireless local area network unit (“WLAN”) 1050, a Bluetooth unit 1052, a Wireless Wide Area Network unit (“WWAN”) 1056, a Global Positioning System (GPS) 1055, a camera (“USB 3.0 camera”) 1054 such as a USB 3.0 camera, and/or a Low Power Double Data Rate (“LPDDR”) memory unit (“LPDDR3”) 1015 implemented in, for example, LPDDR3 standard. These components may each be implemented in any suitable manner.

In at least one embodiment, other components may be communicatively coupled to processor 1010 through components discussed above. In at least one embodiment, an accelerometer 1041, Ambient Light Sensor (“ALS”) 1042, compass 1043, and a gyroscope 1044 may be communicatively coupled to sensor hub 1040. In at least one embodiment, thermal sensor 1039, a fan 1037, a keyboard 1036, and a touch pad 1030 may be communicatively coupled to EC 1035. In at least one embodiment, speakers 1063, headphones 1064, and microphone (“mic”) 1065 may be communicatively coupled to an audio unit (“audio codec and class d amp”) 1062, which may in turn be communicatively coupled to DSP 1060. In at least one embodiment, audio unit 1062 may include, for example and without limitation, an audio coder/decoder (“codec”) and a class D amplifier. In at least one embodiment, SIM card (“SIM”) 1057 may be communicatively coupled to WWAN unit 1056. In at least one embodiment, components such as WLAN unit 1050 and Bluetooth unit 1052, as well as WWAN unit 1056 may be implemented in a Next Generation Form Factor (“NGFF”).

Inference and/or training logic 715 are used to perform inferencing and/or training operations associated with one or more embodiments. Details regarding inference and/or training logic 715 are provided below in conjunction with FIGS. 7A and/or 7B. In at least one embodiment, inference and/or training logic 715 may be used in system FIG. 10 for inferencing or predicting operations based, at least in part, on weight parameters calculated using neural network training operations, neural network functions and/or architectures, or neural network use cases described herein.

Such components can be used to perform visual localization by performing coarse matches using NeRF descriptors and query image features, then fine tuning using higher resolution features.

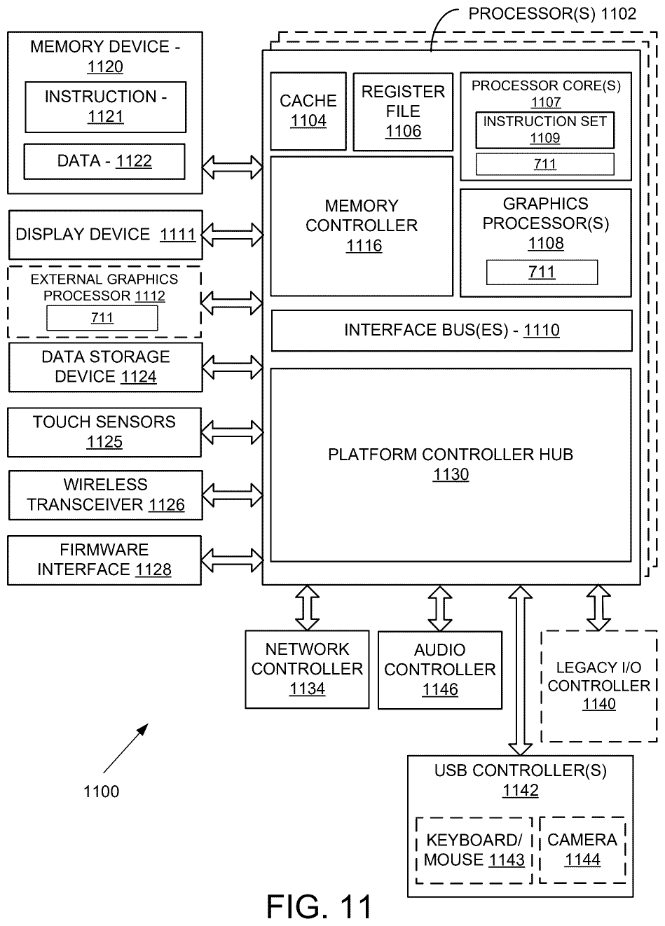

FIG. 11 is a block diagram of a processing system, according to at least one embodiment. In at least one embodiment, system 1100 includes one or more processor(s) 1102 and one or more graphics processor(s) 1108, and may be a single processor desktop system, a multiprocessor workstation system, or a server system having a large number of processor(s) 1102 or processor core(s) 1107. In at least one embodiment, system 1100 is a processing platform incorporated within a system-on-a-chip (SoC) integrated circuit for use in mobile, handheld, or embedded devices.

In at least one embodiment, system 1100 can include, or be incorporated within a server-based gaming platform, a game console, including a game and media console, a mobile gaming console, a handheld game console, or an online game console. In at least one embodiment, system 1100 is a mobile phone, smart phone, tablet computing device or mobile Internet device. In at least one embodiment, processing system 1100 can also include, coupled with, or be integrated within a wearable device, such as a smart watch wearable device, smart eyewear device, augmented reality device, or virtual reality device. In at least one embodiment, processing system 1100 is a television or set top box device having one or more processor(s) 1102 and a graphical interface generated by one or more graphics processor(s) 1108.

In at least one embodiment, one or more processor(s) 1102 each include one or more processor core(s) 1107 to process instructions which, when executed, perform operations for system and user software. In at least one embodiment, each of one or more processor core(s) 1107 is configured to process a specific instruction set 1109. In at least one embodiment, instruction set 1109 may facilitate Complex Instruction Set Computing (CISC), Reduced Instruction Set Computing (RISC), or computing via a Very Long Instruction Word (VLIW). In at least one embodiment, processor core(s) 1107 may each process a different instruction set 1109, which may include instructions to facilitate emulation of other instruction sets. In at least one embodiment, processor core(s) 1107 may also include other processing devices, such a Digital Signal Processor (DSP).

In at least one embodiment, processor(s) 1102 includes cache memory 1104. In at least one embodiment, processor(s) 1102 can have a single internal cache or multiple levels of internal cache. In at least one embodiment, cache memory is shared among various components of processor(s) 1102. In at least one embodiment, processor(s) 1102 also uses an external cache (e.g., a Level-3 (L3) cache or Last Level Cache (LLC)) (not shown), which may be shared among processor core(s) 1107 using known cache coherency techniques. In at least one embodiment, register file 1106 is additionally included in processor(s) 1102 which may include different types of registers for storing different types of data (e.g., integer registers, floating point registers, status registers, and an instruction pointer register). In at least one embodiment, register file 1106 may include general-purpose registers or other registers.

In at least one embodiment, one or more processor(s) 1102 are coupled with one or more interface bus(es) 1110 to transmit communication signals such as address, data, or control signals between processor(s) 1102 and other components in system 1100. In at least one embodiment, interface bus(es) 1110, in one embodiment, can be a processor bus, such as a version of a Direct Media Interface (DMI) bus. In at least one embodiment, interface bus(es) 1110 is not limited to a DMI bus, and may include one or more Peripheral Component Interconnect buses (e.g., PCI, PCI Express), memory busses, or other types of interface busses. In at least one embodiment processor(s) 1102 include an integrated memory controller 1116 and a platform controller hub 1130. In at least one embodiment, memory controller 1116 facilitates communication between a memory device and other components of system 1100, while platform controller hub (PCH) 1130 provides connections to I/O devices via a local I/O bus.

In at least one embodiment, memory device 1120 can be a dynamic random access memory (DRAM) device, a static random access memory (SRAM) device, flash memory device, phase-change memory device, or some other memory device having suitable performance to serve as process memory. In at least one embodiment memory device 1120 can operate as system memory for system 1100, to store data 1122 and instruction 1121 for use when one or more processor(s) 1102 executes an application or process. In at least one embodiment, memory controller 1116 also couples with an optional external graphics processor 1112, which may communicate with one or more graphics processor(s) 1108 in processor(s) 1102 to perform graphics and media operations. In at least one embodiment, a display device 1111 can connect to processor(s) 1102. In at least one embodiment display device 1111 can include one or more of an internal display device, as in a mobile electronic device or a laptop device or an external display device attached via a display interface (e.g., DisplayPort, etc.). In at least one embodiment, display device 1111 can include a head mounted display (HMD) such as a stereoscopic display device for use in virtual reality (VR) applications or augmented reality (AR) applications.

In at least one embodiment, platform controller hub 1130 enables peripherals to connect to memory device 1120 and processor(s) 1102 via a high-speed I/O bus. In at least one embodiment, I/O peripherals include, but are not limited to, an audio controller 1146, a network controller 1134, a firmware interface 1128, a wireless transceiver 1126, touch sensors 1125, a data storage device 1124 (e.g., hard disk drive, flash memory, etc.). In at least one embodiment, data storage device 1124 can connect via a storage interface (e.g., SATA) or via a peripheral bus, such as a Peripheral Component Interconnect bus (e.g., PCI, PCI Express). In at least one embodiment, touch sensors 1125 can include touch screen sensors, pressure sensors, or fingerprint sensors. In at least one embodiment, wireless transceiver 1126 can be a Wi-Fi transceiver, a Bluetooth transceiver, or a mobile network transceiver such as a 3G, 4G, or Long Term Evolution (LTE) transceiver. In at least one embodiment, firmware interface 1128 enables communication with system firmware, and can be, for example, a unified extensible firmware interface (UEFI). In at least one embodiment, network controller 1134 can enable a network connection to a wired network. In at least one embodiment, a high-performance network controller (not shown) couples with interface bus(es) 1110. In at least one embodiment, audio controller 1146 is a multi-channel high definition audio controller. In at least one embodiment, system 1100 includes an optional legacy I/O controller 1140 for coupling legacy (e.g., Personal System 2 (PS/2)) devices to system. In at least one embodiment, platform controller hub 1130 can also connect to one or more Universal Serial Bus (USB) controller(s) 1142 connect input devices, such as keyboard and mouse 1143 combinations, a camera 1144, or other USB input devices.

In at least one embodiment, an instance of memory controller 1116 and platform controller hub 1130 may be integrated into a discreet external graphics processor, such as external graphics processor 1112. In at least one embodiment, platform controller hub 1130 and/or memory controller 1116 may be external to one or more processor(s) 1102. For example, in at least one embodiment, system 1100 can include an external memory controller 1116 and platform controller hub 1130, which may be configured as a memory controller hub and peripheral controller hub within a system chipset that is in communication with processor(s) 1102.

Inference and/or training logic 715 are used to perform inferencing and/or training operations associated with one or more embodiments. Details regarding inference and/or training logic 715 are provided below in conjunction with FIGS. 7A and/or 7B. In at least one embodiment portions or all of inference and/or training logic 715 may be incorporated into graphics processor 1500. For example, in at least one embodiment, training and/or inferencing techniques described herein may use one or more of ALUs embodied in a graphics processor. Moreover, in at least one embodiment, inferencing and/or training operations described herein may be done using logic other than logic illustrated in FIGS. 7A and/or 7B. In at least one embodiment, weight parameters may be stored in on-chip or off-chip memory and/or registers (shown or not shown) that configure ALUs of a graphics processor to perform one or more machine learning algorithms, neural network architectures, use cases, or training techniques described herein.

Such components can be used to perform visual localization by performing coarse matches using NeRF descriptors and query image features, then fine tuning using higher resolution features.

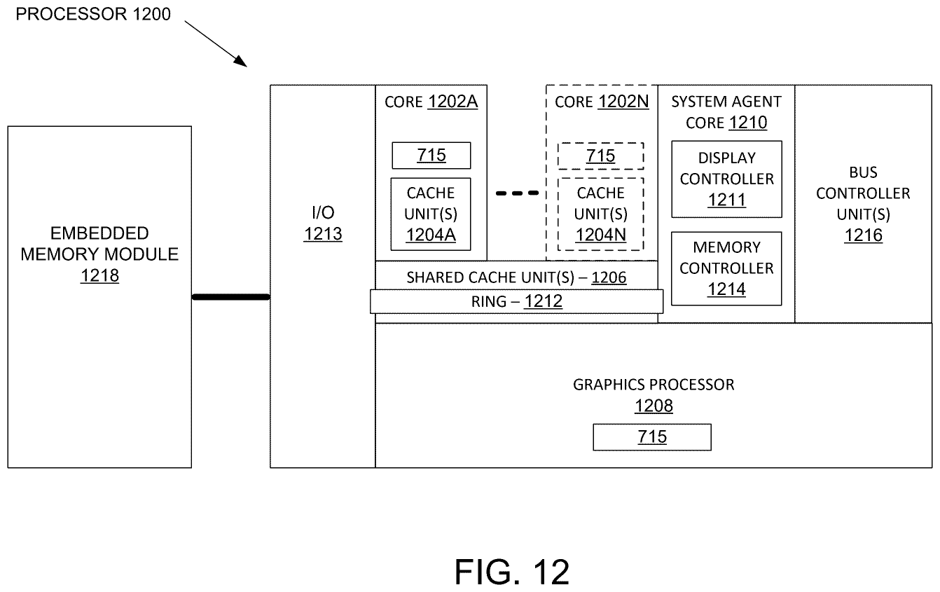

FIG. 12 is a block diagram of a processor 1200 having one or more processor core(s) 1202A-1202N, an integrated memory controller 1214, and an integrated graphics processor 1208, according to at least one embodiment. In at least one embodiment, processor 1200 can include additional cores up to and including additional core 1202N represented by dashed lined boxes. In at least one embodiment, each of processor core(s) 1202A-1202N includes one or more internal cache unit(s) 1204A-1204N. In at least one embodiment, each processor core also has access to one or more shared cached unit(s) 1206.

In at least one embodiment, internal cache unit(s) 1204A-1204N and shared cache unit(s) 1206 represent a cache memory hierarchy within processor 1200. In at least one embodiment, cache unit(s) 1204A-1204N may include at least one level of instruction and data cache within each processor core and one or more levels of shared mid-level cache, such as a Level 2 (L2), Level 3 (L3), Level 4 (L4), or other levels of cache, where a highest level of cache before external memory is classified as an LLC. In at least one embodiment, cache coherency logic maintains coherency between various cache unit(s) 1206 and 1204A-1204N.

In at least one embodiment, processor 1200 may also include a set of one or more bus controller unit(s) 1216 and a system agent core 1210. In at least one embodiment, one or more bus controller unit(s) 1216 manage a set of peripheral buses, such as one or more PCI or PCI express busses. In at least one embodiment, system agent core 1210 provides management functionality for various processor components. In at least one embodiment, system agent core 1210 includes one or more integrated memory controllers 1214 to manage access to various external memory devices (not shown).

In at least one embodiment, one or more of processor core(s) 1202A-1202N include support for simultaneous multi-threading. In at least one embodiment, system agent core 1210 includes components for coordinating and processor core(s) 1202A-1202N during multi-threaded processing. In at least one embodiment, system agent core 1210 may additionally include a power control unit (PCU), which includes logic and components to regulate one or more power states of processor core(s) 1202A-1202N and graphics processor 1208.

In at least one embodiment, processor 1200 additionally includes graphics processor 1208 to execute graphics processing operations. In at least one embodiment, graphics processor 1208 couples with shared cache unit(s) 1206, and system agent core 1210, including one or more integrated memory controllers 1214. In at least one embodiment, system agent core 1210 also includes a display controller 1211 to drive graphics processor output to one or more coupled displays. In at least one embodiment, display controller 1211 may also be a separate module coupled with graphics processor 1208 via at least one interconnect, or may be integrated within graphics processor 1208.

In at least one embodiment, a ring based interconnect unit 1212 is used to couple internal components of processor 1200. In at least one embodiment, an alternative interconnect unit may be used, such as a point-to-point interconnect, a switched interconnect, or other techniques. In at least one embodiment, graphics processor 1208 couples with a ring based interconnect unit 1212 via an I/O link 1213.

In at least one embodiment, I/O link 1213 represents at least one of multiple varieties of I/O interconnects, including an on package I/O interconnect which facilitates communication between various processor components and a high-performance embedded memory module 1218, such as an eDRAM module. In at least one embodiment, each of processor core(s) 1202A-1202N and graphics processor 1208 use embedded memory modules 1218 as a shared Last Level Cache.

In at least one embodiment, processor core(s) 1202A-1202N are homogenous cores executing a common instruction set architecture. In at least one embodiment, processor core(s) 1202A-1202N are heterogeneous in terms of instruction set architecture (ISA), where one or more of processor core(s) 1202A-1202N execute a common instruction set, while one or more other cores of processor core(s) 1202A-1202N executes a subset of a common instruction set or a different instruction set. In at least one embodiment, processor core(s) 1202A-1202N are heterogeneous in terms of microarchitecture, where one or more cores having a relatively higher power consumption couple with one or more power cores having a lower power consumption. In at least one embodiment, processor 1200 can be implemented on one or more chips or as an SoC integrated circuit.

Inference and/or training logic 715 are used to perform inferencing and/or training operations associated with one or more embodiments. Details regarding inference and/or training logic 715 are provided below in conjunction with FIGS. 7A and/or 7B. In at least one embodiment portions or all of inference and/or training logic 715 may be incorporated into processor 1200. For example, in at least one embodiment, training and/or inferencing techniques described herein may use one or more of ALUs embodied in graphics processor 1208, graphics core(s) 1202A-1202N, or other components in FIG. 12. Moreover, in at least one embodiment, inferencing and/or training operations described herein may be done using logic other than logic illustrated in FIGS. 7A and/or 7B. In at least one embodiment, weight parameters may be stored in on-chip or off-chip memory and/or registers (shown or not shown) that configure ALUs of graphics processor 1200 to perform one or more machine learning algorithms, neural network architectures, use cases, or training techniques described herein.

Such components can be used to perform visual localization by performing coarse matches using NeRF descriptors and query image features, then fine tuning using higher resolution features.

### Virtualized Computing Platform

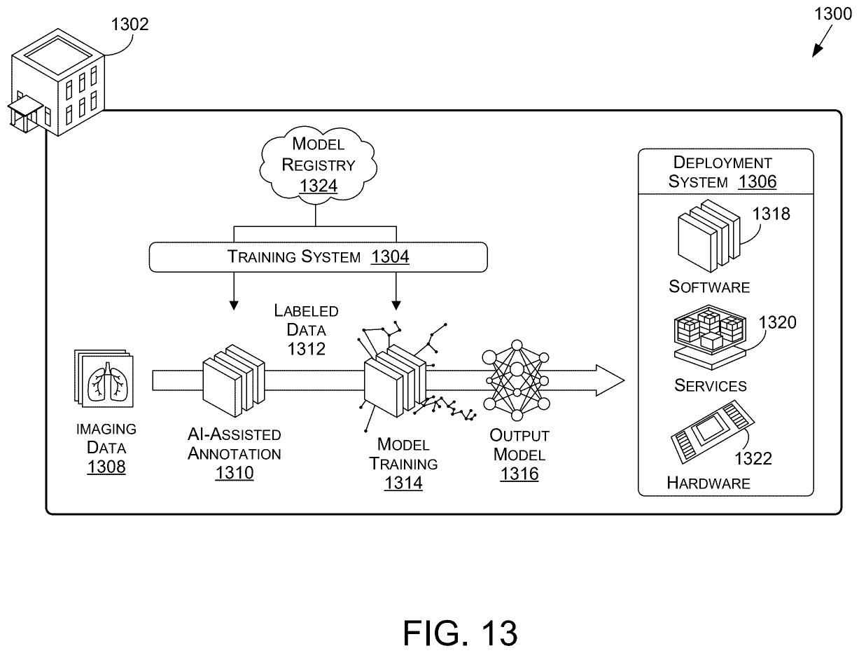

FIG. 13 is an example data flow diagram for a process 1300 of generating and deploying an image processing and inferencing pipeline, in accordance with at least one embodiment. In at least one embodiment, process 1300 may be deployed for use with imaging devices, processing devices, and/or other device types at one or more facilities 1302. Process 1300 may be executed within a training system 1304 and/or a deployment system 1306. In at least one embodiment, training system 1304 may be used to perform training, deployment, and implementation of machine learning models (e.g., neural networks, object detection algorithms, computer vision algorithms, etc.) for use in deployment system 1306. In at least one embodiment, deployment system 1306 may be configured to offload processing and compute resources among a distributed computing environment to reduce infrastructure requirements at facility 1302. In at least one embodiment, one or more applications in a pipeline may use or call upon services (e.g., inference, visualization, compute, AI, etc.) of deployment system 1306 during execution of applications.

In at least one embodiment, some of applications used in advanced processing and inferencing pipelines may use machine learning models or other AI to perform one or more processing steps. In at least one embodiment, machine learning models may be trained at facility 1302 using data 1308 (such as imaging data) generated at facility 1302 (and stored on one or more picture archiving and communication system (PACS) servers at facility 1302), may be trained using imaging or sequencing data 1308 from another facility(ies), or a combination thereof. In at least one embodiment, training system 1304 may be used to provide applications, services, and/or other resources for generating working, deployable machine learning models for deployment system 1306.

In at least one embodiment, model registry 1324 may be backed by object storage that may support versioning and object metadata. In at least one embodiment, object storage may be accessible through, for example, a cloud storage compatible application programming interface (API) from within a cloud platform. In at least one embodiment, machine learning models within model registry 1324 may uploaded, listed, modified, or deleted by developers or partners of a system interacting with an API. In at least one embodiment, an API may provide access to methods that allow users with appropriate credentials to associate models with applications, such that models may be executed as part of execution of containerized instantiations of applications.

In at least one embodiment, training system 1304 (FIG. 13) may include a scenario where facility 1302 is training their own machine learning model, or has an existing machine learning model that needs to be optimized or updated. In at least one embodiment, imaging data 1308 generated by imaging device(s), sequencing devices, and/or other device types may be received. In at least one embodiment, once imaging data 1308 is received, AI-assisted annotation 1310 may be used to aid in generating annotations corresponding to imaging data 1308 to be used as ground truth data for a machine learning model. In at least one embodiment, AI-assisted annotation 1310 may include one or more machine learning models (e.g., convolutional neural networks (CNNs)) that may be trained to generate annotations corresponding to certain types of imaging data 1308 (e.g., from certain devices). In at least one embodiment, AI-assisted annotation 1310 may then be used directly, or may be adjusted or fine-tuned using an annotation tool to generate ground truth data. In at least one embodiment, AI-assisted annotation 1310, labeled data 1312, or a combination thereof may be used as ground truth data for training a machine learning model. In at least one embodiment, a trained machine learning model may be referred to as output model(s) 1316, and may be used by deployment system 1306, as described herein.

In at least one embodiment, a training pipeline may include a scenario where facility 1302 needs a machine learning model for use in performing one or more processing tasks for one or more applications in deployment system 1306, but facility 1302 may not currently have such a machine learning model (or may not have a model that is optimized, efficient, or effective for such purposes). In at least one embodiment, an existing machine learning model may be selected from a model registry 1324. In at least one embodiment, model registry 1324 may include machine learning models trained to perform a variety of different inference tasks on imaging data. In at least one embodiment, machine learning models in model registry 1324 may have been trained on imaging data from different facilities than facility 1302 (e.g., facilities remotely located). In at least one embodiment, machine learning models may have been trained on imaging data from one location, two locations, or any number of locations. In at least one embodiment, when being trained on imaging data from a specific location, training may take place at that location, or at least in a manner that protects confidentiality of imaging data or restricts imaging data from being transferred off-premises. In at least one embodiment, once a model is trained—or partially trained—at one location, a machine learning model may be added to model registry 1324. In at least one embodiment, a machine learning model may then be retrained, or updated, at any number of other facilities, and a retrained or updated model may be made available in model registry 1324. In at least one embodiment, a machine learning model may then be selected from model registry 1324—and referred to as output model(s) 1316—and may be used in deployment system 1306 to perform one or more processing tasks for one or more applications of a deployment system.

In at least one embodiment, a scenario may include facility 1302 requiring a machine learning model for use in performing one or more processing tasks for one or more applications in deployment system 1306, but facility 1302 may not currently have such a machine learning model (or may not have a model that is optimized, efficient, or effective for such purposes). In at least one embodiment, a machine learning model selected from model registry 1324 may not be fine-tuned or optimized for imaging data 1308 generated at facility 1302 because of differences in populations, robustness of training data used to train a machine learning model, diversity in anomalies of training data, and/or other issues with training data. In at least one embodiment, AI-assisted annotation 1310 may be used to aid in generating annotations corresponding to imaging data 1308 to be used as ground truth data for retraining or updating a machine learning model. In at least one embodiment, labeled data 1312 may be used as ground truth data for training a machine learning model. In at least one embodiment, retraining or updating a machine learning model may be referred to as model training 1314. In at least one embodiment, model training 1314—e.g., AI-assisted annotation 1310, labeled data 1312, or a combination thereof—may be used as ground truth data for retraining or updating a machine learning model. In at least one embodiment, a trained machine learning model may be referred to as output model(s) 1316, and may be used by deployment system 1306, as described herein.

In at least one embodiment, deployment system 1306 may include software 1318, services 1320, hardware 1322, and/or other components, features, and functionality. In at least one embodiment, deployment system 1306 may include a software “stack,” such that software 1318 may be built on top of services 1320 and may use services 1320 to perform some or all of processing tasks, and services 1320 and software 1318 may be built on top of hardware 1322 and use hardware 1322 to execute processing, storage, and/or other compute tasks of deployment system 1306. In at least one embodiment, software 1318 may include any number of different containers, where each container may execute an instantiation of an application. In at least one embodiment, each application may perform one or more processing tasks in an advanced processing and inferencing pipeline (e.g., inferencing, object detection, feature detection, segmentation, image enhancement, calibration, etc.). In at least one embodiment, an advanced processing and inferencing pipeline may be defined based on selections of different containers that are desired or required for processing imaging data 1308, in addition to containers that receive and configure imaging data for use by each container and/or for use by facility 1302 after processing through a pipeline (e.g., to convert outputs back to a usable data type). In at least one embodiment, a combination of containers within software 1318 (e.g., that make up a pipeline) may be referred to as a virtual instrument (as described in more detail herein), and a virtual instrument may leverage services 1320 and hardware 1322 to execute some or all processing tasks of applications instantiated in containers.

In at least one embodiment, a data processing pipeline may receive input data (e.g., imaging data 1308) in a specific format in response to an inference request (e.g., a request from a user of deployment system 1306). In at least one embodiment, input data may be representative of one or more images, video, and/or other data representations generated by one or more imaging devices. In at least one embodiment, data may undergo pre-processing as part of data processing pipeline to prepare data for processing by one or more applications. In at least one embodiment, post-processing may be performed on an output of one or more inferencing tasks or other processing tasks of a pipeline to prepare an output data for a next application and/or to prepare output data for transmission and/or use by a user (e.g., as a response to an inference request). In at least one embodiment, inferencing tasks may be performed by one or more machine learning models, such as trained or deployed neural networks, which may include output model(s) 1316 of training system 1304.

In at least one embodiment, tasks of data processing pipeline may be encapsulated in a container(s) that each represents a discrete, fully functional instantiation of an application and virtualized computing environment that is able to reference machine learning models. In at least one embodiment, containers or applications may be published into a private (e.g., limited access) area of a container registry (described in more detail herein), and trained or deployed models may be stored in model registry 1324 and associated with one or more applications. In at least one embodiment, images of applications (e.g., container images) may be available in a container registry, and once selected by a user from a container registry for deployment in a pipeline, an image may be used to generate a container for an instantiation of an application for use by a user's system.

In at least one embodiment, developers (e.g., software developers, clinicians, doctors, etc.) may develop, publish, and store applications (e.g., as containers) for performing image processing and/or inferencing on supplied data. In at least one embodiment, development, publishing, and/or storing may be performed using a software development kit (SDK) associated with a system (e.g., to ensure that an application and/or container developed is compliant with or compatible with a system). In at least one embodiment, an application that is developed may be tested locally (e.g., at a first facility, on data from a first facility) with an SDK which may support at least some of services 1320 as a system (e.g., system 1200 of FIG. 12). In at least one embodiment, because DICOM objects may contain anywhere from one to hundreds of images or other data types, and due to a variation in data, a developer may be responsible for managing (e.g., setting constructs for, building pre-processing into an application, etc.) extraction and preparation of incoming data. In at least one embodiment, once validated by system 1300 (e.g., for accuracy), an application may be available in a container registry for selection and/or implementation by a user to perform one or more processing tasks with respect to data at a facility (e.g., a second facility) of a user.

In at least one embodiment, developers may then share applications or containers through a network for access and use by users of a system (e.g., system 1300 of FIG. 13). In at least one embodiment, completed and validated applications or containers may be stored in a container registry and associated machine learning models may be stored in model registry 1324. In at least one embodiment, a requesting entity—who provides an inference or image processing request—may browse a container registry and/or model registry 1324 for an application, container, dataset, machine learning model, etc., select a desired combination of elements for inclusion in data processing pipeline, and submit an imaging processing request. In at least one embodiment, a request may include input data (and associated patient data, in some examples) that is necessary to perform a request, and/or may include a selection of application(s) and/or machine learning models to be executed in processing a request. In at least one embodiment, a request may then be passed to one or more components of deployment system 1306 (e.g., a cloud) to perform processing of data processing pipeline. In at least one embodiment, processing by deployment system 1306 may include referencing selected elements (e.g., applications, containers, models, etc.) from a container registry and/or model registry 1324. In at least one embodiment, once results are generated by a pipeline, results may be returned to a user for reference (e.g., for viewing in a viewing application suite executing on a local, on-premises workstation or terminal).

In at least one embodiment, to aid in processing or execution of applications or containers in pipelines, services 1320 may be leveraged. In at least one embodiment, services 1320 may include compute services, artificial intelligence (AI) services, visualization services, and/or other service types. In at least one embodiment, services 1320 may provide functionality that is common to one or more applications in software 1318, so functionality may be abstracted to a service that may be called upon or leveraged by applications. In at least one embodiment, functionality provided by services 1320 may run dynamically and more efficiently, while also scaling well by allowing applications to process data in parallel (e.g., using a parallel computing platform 1230 (FIG. 12)). In at least one embodiment, rather than each application that shares a same functionality offered by services 1320 being required to have a respective instance of services 1320, services 1320 may be shared between and among various applications. In at least one embodiment, services may include an inference server or engine that may be used for executing detection or segmentation tasks, as non-limiting examples. In at least one embodiment, a model training service may be included that may provide machine learning model training and/or retraining capabilities. In at least one embodiment, a data augmentation service may further be included that may provide GPU accelerated data (e.g., DICOM, RIS, CIS, REST compliant, RPC, raw, etc.) extraction, resizing, scaling, and/or other augmentation. In at least one embodiment, a visualization service may be used that may add image rendering effects—such as ray-tracing, rasterization, denoising, sharpening, etc.—to add realism to two-dimensional (2D) and/or three-dimensional (3D) models. In at least one embodiment, virtual instrument services may be included that provide for beam-forming, segmentation, inferencing, imaging, and/or support for other applications within pipelines of virtual instruments.

In at least one embodiment, where services 1320 includes an AI service (e.g., an inference service), one or more machine learning models may be executed by calling upon (e.g., as an API call) an inference service (e.g., an inference server) to execute machine learning model(s), or processing thereof, as part of application execution. In at least one embodiment, where another application includes one or more machine learning models for segmentation tasks, an application may call upon an inference service to execute machine learning models for performing one or more of processing operations associated with segmentation tasks. In at least one embodiment, software 1318 implementing advanced processing and inferencing pipeline that includes segmentation application and anomaly detection application may be streamlined because each application may call upon a same inference service to perform one or more inferencing tasks.

In at least one embodiment, hardware 1322 may include GPUs, CPUs, graphics cards, an AI/deep learning system (e.g., an AI supercomputer, such as NVIDIA's DGX), a cloud platform, or a combination thereof. In at least one embodiment, different types of hardware 1322 may be used to provide efficient, purpose-built support for software 1318 and services 1320 in deployment system 1306. In at least one embodiment, use of GPU processing may be implemented for processing locally (e.g., at facility 1302), within an AI/deep learning system, in a cloud system, and/or in other processing components of deployment system 1306 to improve efficiency, accuracy, and efficacy of image processing and generation. In at least one embodiment, software 1318 and/or services 1320 may be optimized for GPU processing with respect to deep learning, machine learning, and/or high-performance computing, as non-limiting examples. In at least one embodiment, at least some of computing environment of deployment system 1306 and/or training system 1304 may be executed in a datacenter one or more supercomputers or high performance computing systems, with GPU optimized software (e.g., hardware and software combination of NVIDIA's DGX System). In at least one embodiment, hardware 1322 may include any number of GPUs that may be called upon to perform processing of data in parallel, as described herein. In at least one embodiment, cloud platform may further include GPU processing for GPU-optimized execution of deep learning tasks, machine learning tasks, or other computing tasks. In at least one embodiment, cloud platform (e.g., NVIDIA's NGC) may be executed using an AI/deep learning supercomputer(s) and/or GPU-optimized software (e.g., as provided on NVIDIA's DGX Systems) as a hardware abstraction and scaling platform. In at least one embodiment, cloud platform may integrate an application container clustering system or orchestration system (e.g., KUBERNETES) on multiple GPUs to enable seamless scaling and load balancing.

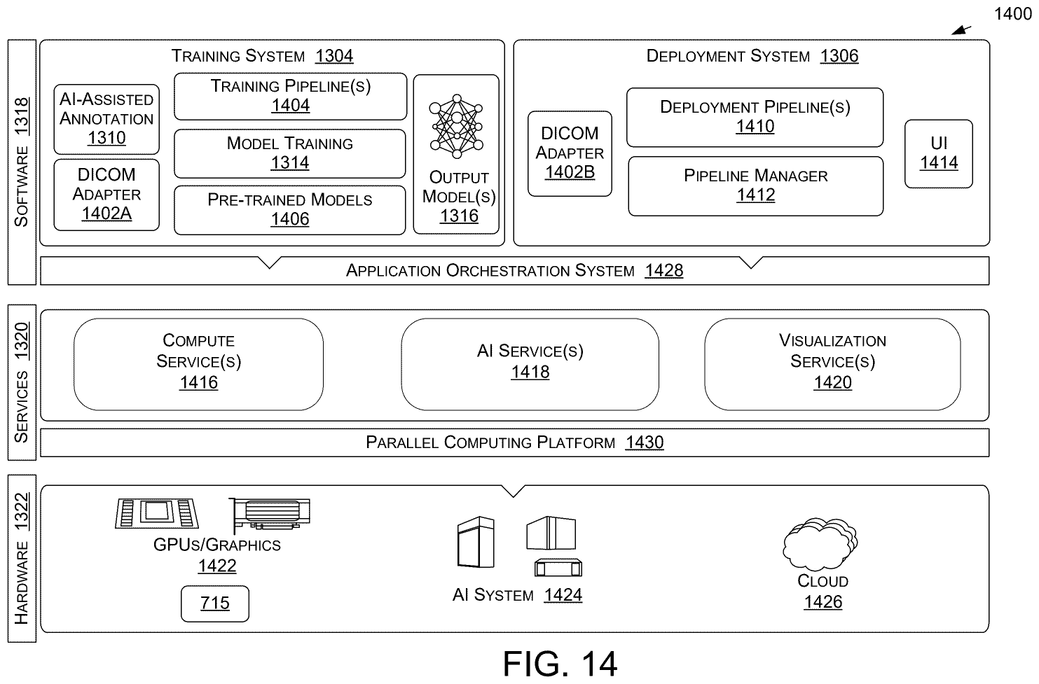

FIG. 14 is a system diagram for an example system 1400 for generating and deploying an imaging deployment pipeline, in accordance with at least one embodiment. In at least one embodiment, system 1400 may be used to implement process 1300 of FIG. 13 and/or other processes including advanced processing and inferencing pipelines. In at least one embodiment, system 1400 may include training system 1304 and deployment system 1306. In at least one embodiment, training system 1304 and deployment system 1306 may be implemented using software 1318, services 1320, and/or hardware 1322, as described herein.

In at least one embodiment, system 1400 (e.g., training system 1304 and/or deployment system 1306) may implemented in a cloud computing environment (e.g., using cloud 1426). In at least one embodiment, system 1400 may be implemented locally with respect to a healthcare services facility, or as a combination of both cloud and local computing resources. In at least one embodiment, access to APIs in cloud 1426 may be restricted to authorized users through enacted security measures or protocols. In at least one embodiment, a security protocol may include web tokens that may be signed by an authentication (e.g., AuthN, AuthZ, Gluecon, etc.) service and may carry appropriate authorization. In at least one embodiment, APIs of virtual instruments (described herein), or other instantiations of system 1400, may be restricted to a set of public IPs that have been vetted or authorized for interaction.

In at least one embodiment, various components of system 1400 may communicate between and among one another using any of a variety of different network types, including but not limited to local area networks (LANs) and/or wide area networks (WANs) via wired and/or wireless communication protocols. In at least one embodiment, communication between facilities and components of system 1400 (e.g., for transmitting inference requests, for receiving results of inference requests, etc.) may be communicated over data bus(ses), wireless data protocols (Wi-Fi), wired data protocols (e.g., Ethernet), etc.

In at least one embodiment, training system 1304 may execute training pipelines 1404, similar to those described herein with respect to FIG. 13. In at least one embodiment, where one or more machine learning models are to be used in deployment pipeline(s) 1410 by deployment system 1306, training pipelines 1404 may be used to train or retrain one or more (e.g. pre-trained) models, and/or implement one or more of pre-trained models 1406 (e.g., without a need for retraining or updating). In at least one embodiment, as a result of training pipelines 1404, output model(s) 1316 may be generated. In at least one embodiment, training pipelines 1404 may include any number of processing steps, such as but not limited to imaging data (or other input data) conversion or adaption In at least one embodiment, for different machine learning models used by deployment system 1306, different training pipelines 1404 may be used. In at least one embodiment, training pipeline 1404 similar to a first example described with respect to FIG. 13 may be used for a first machine learning model, training pipeline 1404 similar to a second example described with respect to FIG. 13 may be used for a second machine learning model, and training pipeline 1404 similar to a third example described with respect to FIG. 13 may be used for a third machine learning model. In at least one embodiment, any combination of tasks within training system 1304 may be used depending on what is required for each respective machine learning model. In at least one embodiment, one or more of machine learning models may already be trained and ready for deployment so machine learning models may not undergo any processing by training system 1304, and may be implemented by deployment system 1306.

In at least one embodiment, output model(s) 1316 and/or pre-trained models 1406 may include any types of machine learning models depending on implementation or embodiment. In at least one embodiment, and without limitation, machine learning models used by system 1400 may include machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Hopfield, Boltzmann, deep belief, deconvolutional, generative adversarial, liquid state machine, etc.), and/or other types of machine learning models.

In at least one embodiment, training pipelines 1404 may include AI-assisted annotation, as described in more detail herein with respect to at least FIG. 14B. In at least one embodiment, labeled data 1312 (e.g., traditional annotation) may be generated by any number of techniques. In at least one embodiment, labels or other annotations may be generated within a drawing program (e.g., an annotation program), a computer aided design (CAD) program, a labeling program, another type of program suitable for generating annotations or labels for ground truth, and/or may be hand drawn, in some examples. In at least one embodiment, ground truth data may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines location of labels), and/or a combination thereof. In at least one embodiment, for each instance of imaging data 1308 (or other data type used by machine learning models), there may be corresponding ground truth data generated by training system 1304. In at least one embodiment, AI-assisted annotation may be performed as part of deployment pipeline(s) 1410; either in addition to, or in lieu of AI-assisted annotation included in training pipelines 1404. In at least one embodiment, system 1400 may include a multi-layer platform that may include a software layer (e.g., software 1318) of diagnostic applications (or other application types) that may perform one or more medical imaging and diagnostic functions. In at least one embodiment, system 1400 may be communicatively coupled to (e.g., via encrypted links) PACS server networks of one or more facilities. In at least one embodiment, system 1400 may be configured to access and referenced data from PACS servers to perform operations, such as training machine learning models, deploying machine learning models, image processing, inferencing, and/or other operations.

In at least one embodiment, a software layer may be implemented as a secure, encrypted, and/or authenticated API through which applications or containers may be invoked (e.g., called) from an external environment(s) (e.g., facility 1302). In at least one embodiment, applications may then call or execute one or more services 1320 for performing compute, AI, or visualization tasks associated with respective applications, and software 1318 and/or services 1320 may leverage hardware 1322 to perform processing tasks in an effective and efficient manner. In at least one embodiment, communications sent to, or received by, a training system 1304 and a deployment system 1306 may occur using a pair of DICOM adapters 1402A, 1402B.

In at least one embodiment, deployment system 1306 may execute deployment pipeline(s) 1410. In at least one embodiment, deployment pipeline(s) 1410 may include any number of applications that may be sequentially, non-sequentially, or otherwise applied to imaging data (and/or other data types) generated by imaging devices, sequencing devices, genomics devices, etc.—including AI-assisted annotation, as described above. In at least one embodiment, as described herein, a deployment pipeline(s) 1410 for an individual device may be referred to as a virtual instrument for a device (e.g., a virtual ultrasound instrument, a virtual CT scan instrument, a virtual sequencing instrument, etc.). In at least one embodiment, for a single device, there may be more than one deployment pipeline(s) 1410 depending on information desired from data generated by a device. In at least one embodiment, where detections of anomalies are desired from an MRI machine, there may be a first deployment pipeline(s) 1410, and where image enhancement is desired from output of an MRI machine, there may be a second deployment pipeline(s) 1410.

In at least one embodiment, an image generation application may include a processing task that includes use of a machine learning model. In at least one embodiment, a user may desire to use their own machine learning model, or to select a machine learning model from model registry 1324. In at least one embodiment, a user may implement their own machine learning model or select a machine learning model for inclusion in an application for performing a processing task. In at least one embodiment, applications may be selectable and customizable, and by defining constructs of applications, deployment and implementation of applications for a particular user are presented as a more seamless user experience. In at least one embodiment, by leveraging other features of system 1400—such as services 1320 and hardware 1322—deployment pipeline(s) 1410 may be even more user friendly, provide for easier integration, and produce more accurate, efficient, and timely results.

In at least one embodiment, deployment system 1306 may include a user interface (“UI”) 1414 (e.g., a graphical user interface, a web interface, etc.) that may be used to select applications for inclusion in deployment pipeline(s) 1410, arrange applications, modify or change applications or parameters or constructs thereof, use and interact with deployment pipeline(s) 1410 during set-up and/or deployment, and/or to otherwise interact with deployment system 1306. In at least one embodiment, although not illustrated with respect to training system 1304, UI 1414 (or a different user interface) may be used for selecting models for use in deployment system 1306, for selecting models for training, or retraining, in training system 1304, and/or for otherwise interacting with training system 1304.

In at least one embodiment, pipeline manager 1412 may be used, in addition to an application orchestration system 1428, to manage interaction between applications or containers of deployment pipeline(s) 1410 and services 1320 and/or hardware 1322. In at least one embodiment, pipeline manager 1412 may be configured to facilitate interactions from application to application, from application to services 1320, and/or from application or service to hardware 1322. In at least one embodiment, although illustrated as included in software 1318, this is not intended to be limiting, and in some examples pipeline manager 1412 may be included in services 1320. In at least one embodiment, application orchestration system 1428 (e.g., Kubernetes, DOCKER, etc.) may include a container orchestration system that may group applications into containers as logical units for coordination, management, scaling, and deployment. In at least one embodiment, by associating applications from deployment pipeline(s) 1410 (e.g., a reconstruction application, a segmentation application, etc.) with individual containers, each application may execute in a self-contained environment (e.g., at a kernel level) to increase speed and efficiency.

In at least one embodiment, each application and/or container (or image thereof) may be individually developed, modified, and deployed (e.g., a first user or developer may develop, modify, and deploy a first application and a second user or developer may develop, modify, and deploy a second application separate from a first user or developer), which may allow for focus on, and attention to, a task of a single application and/or container(s) without being hindered by tasks of another application(s) or container(s). In at least one embodiment, communication, and cooperation between different containers or applications may be aided by pipeline manager 1412 and application orchestration system 1428. In at least one embodiment, so long as an expected input and/or output of each container or application is known by a system (e.g., based on constructs of applications or containers), application orchestration system 1428 and/or pipeline manager 1412 may facilitate communication among and between, and sharing of resources among and between, each of applications or containers. In at least one embodiment, because one or more of applications or containers in deployment pipeline(s) 1410 may share same services and resources, application orchestration system 1428 may orchestrate, load balance, and determine sharing of services or resources between and among various applications or containers. In at least one embodiment, a scheduler may be used to track resource requirements of applications or containers, current usage or planned usage of these resources, and resource availability. In at least one embodiment, a scheduler may thus allocate resources to different applications and distribute resources between and among applications in view of requirements and availability of a system. In some examples, a scheduler (and/or other component of application orchestration system 1428) may determine resource availability and distribution based on constraints imposed on a system (e.g., user constraints), such as quality of service (QoS), urgency of need for data outputs (e.g., to determine whether to execute real-time processing or delayed processing), etc.

In at least one embodiment, services 1320 leveraged by and shared by applications or containers in deployment system 1306 may include compute service(s) 1416, AI service(s) 1418, visualization service(s) 1420, and/or other service types. In at least one embodiment, applications may call (e.g., execute) one or more of services 1320 to perform processing operations for an application. In at least one embodiment, compute service(s) 1416 may be leveraged by applications to perform super-computing or other high-performance computing (HPC) tasks. In at least one embodiment, compute service(s) 1416 may be leveraged to perform parallel processing (e.g., using a parallel computing platform 1430) for processing data through one or more of applications and/or one or more tasks of a single application, substantially simultaneously. In at least one embodiment, parallel computing platform 1430 (e.g., NVIDIA's CUDA) may enable general purpose computing on GPUs (GPGPU) (e.g., GPUs/Graphics 1422). In at least one embodiment, a software layer of parallel computing platform 1430 may provide access to virtual instruction sets and parallel computational elements of GPUs, for execution of compute kernels. In at least one embodiment, parallel computing platform 1430 may include memory and, in some embodiments, a memory may be shared between and among multiple containers, and/or between and among different processing tasks within a single container. In at least one embodiment, inter-process communication (IPC) calls may be generated for multiple containers and/or for multiple processes within a container to use same data from a shared segment of memory of parallel computing platform 1430 (e.g., where multiple different stages of an application or multiple applications are processing same information). In at least one embodiment, rather than making a copy of data and moving data to different locations in memory (e.g., a read/write operation), same data in same location of a memory may be used for any number of processing tasks (e.g., at a same time, at different times, etc.). In at least one embodiment, as data is used to generate new data as a result of processing, this information of a new location of data may be stored and shared between various applications. In at least one embodiment, location of data and a location of updated or modified data may be part of a definition of how a payload is understood within containers.

In at least one embodiment, AI service(s) 1418 may be leveraged to perform inferencing services for executing machine learning model(s) associated with applications (e.g., tasked with performing one or more processing tasks of an application). In at least one embodiment, AI service(s) 1418 may leverage AI system 1424 to execute machine learning model(s) (e.g., neural networks, such as CNNs) for segmentation, reconstruction, object detection, feature detection, classification, and/or other inferencing tasks. In at least one embodiment, applications of deployment pipeline(s) 1410 may use one or more of output model(s) 1316 from training system 1304 and/or other models of applications to perform inference on imaging data. In at least one embodiment, two or more examples of inferencing using application orchestration system 1428 (e.g., a scheduler) may be available. In at least one embodiment, a first category may include a high priority/low latency path that may achieve higher service level agreements, such as for performing inference on urgent requests during an emergency, or for a radiologist during diagnosis. In at least one embodiment, a second category may include a standard priority path that may be used for requests that may be non-urgent or where analysis may be performed at a later time. In at least one embodiment, application orchestration system 1428 may distribute resources (e.g., services 1320 and/or hardware 1322) based on priority paths for different inferencing tasks of AI service(s) 1418.

In at least one embodiment, shared storage may be mounted to AI service(s) 1418 within system 1400. In at least one embodiment, shared storage may operate as a cache (or other storage device type) and may be used to process inference requests from applications. In at least one embodiment, when an inference request is submitted, a request may be received by a set of API instances of deployment system 1306, and one or more instances may be selected (e.g., for best fit, for load balancing, etc.) to process a request. In at least one embodiment, to process a request, a request may be entered into a database, a machine learning model may be located from model registry 1324 if not already in a cache, a validation step may ensure appropriate machine learning model is loaded into a cache (e.g., shared storage), and/or a copy of a model may be saved to a cache. In at least one embodiment, a scheduler (e.g., of pipeline manager 1412) may be used to launch an application that is referenced in a request if an application is not already running or if there are not enough instances of an application. In at least one embodiment, if an inference server is not already launched to execute a model, an inference server may be launched. Any number of inference servers may be launched per model. In at least one embodiment, in a pull model, in which inference servers are clustered, models may be cached whenever load balancing is advantageous. In at least one embodiment, inference servers may be statically loaded in corresponding, distributed servers.

In at least one embodiment, inferencing may be performed using an inference server that runs in a container. In at least one embodiment, an instance of an inference server may be associated with a model (and optionally a plurality of versions of a model). In at least one embodiment, if an instance of an inference server does not exist when a request to perform inference on a model is received, a new instance may be loaded. In at least one embodiment, when starting an inference server, a model may be passed to an inference server such that a same container may be used to serve different models so long as inference server is running as a different instance.

In at least one embodiment, during application execution, an inference request for a given application may be received, and a container (e.g., hosting an instance of an inference server) may be loaded (if not already), and a start procedure may be called. In at least one embodiment, pre-processing logic in a container may load, decode, and/or perform any additional pre-processing on incoming data (e.g., using a CPU(s) and/or GPU(s)). In at least one embodiment, once data is prepared for inference, a container may perform inference as necessary on data. In at least one embodiment, this may include a single inference call on one image (e.g., a hand X-ray), or may require inference on hundreds of images (e.g., a chest CT). In at least one embodiment, an application may summarize results before completing, which may include, without limitation, a single confidence score, pixel level-segmentation, voxel-level segmentation, generating a visualization, or generating text to summarize findings. In at least one embodiment, different models or applications may be assigned different priorities. For example, some models may have a real-time (TAT<1 min) priority while others may have lower priority (e.g., TAT<10 min). In at least one embodiment, model execution times may be measured from requesting institution or entity and may include partner network traversal time, as well as execution on an inference service.

In at least one embodiment, transfer of requests between services 1320 and inference applications may be hidden behind a software development kit (SDK), and robust transport may be provided through a queue. In at least one embodiment, a request will be placed in a queue via an API for an individual application/tenant ID combination and an SDK will pull a request from a queue and give a request to an application. In at least one embodiment, a name of a queue may be provided in an environment from where an SDK will pick it up. In at least one embodiment, asynchronous communication through a queue may be useful as it may allow any instance of an application to pick up work as it becomes available. Results may be transferred back through a queue, to ensure no data is lost. In at least one embodiment, queues may also provide an ability to segment work, as highest priority work may go to a queue with most instances of an application connected to it, while lowest priority work may go to a queue with a single instance connected to it that processes tasks in an order received. In at least one embodiment, an application may run on a GPU-accelerated instance generated in cloud 1426, and an inference service may perform inferencing on a GPU.

In at least one embodiment, visualization service(s) 1420 may be leveraged to generate visualizations for viewing outputs of applications and/or deployment pipeline(s) 1410. In at least one embodiment, GPUs/Graphics 1422 may be leveraged by visualization service(s) 1420 to generate visualizations. In at least one embodiment, rendering effects, such as ray-tracing, may be implemented by visualization service(s) 1420 to generate higher quality visualizations. In at least one embodiment, visualizations may include, without limitation, 2D image renderings, 3D volume renderings, 3D volume reconstruction, 2D tomographic slices, virtual reality displays, augmented reality displays, etc. In at least one embodiment, virtualized environments may be used to generate a virtual interactive display or environment (e.g., a virtual environment) for interaction by users of a system (e.g., doctors, nurses, radiologists, etc.). In at least one embodiment, visualization service(s) 1420 may include an internal visualizer, cinematics, and/or other rendering or image processing capabilities or functionality (e.g., ray tracing, rasterization, internal optics, etc.).

In at least one embodiment, hardware 1322 may include GPUs/Graphics 1422, AI system 1424, cloud 1426, and/or any other hardware used for executing training system 1304 and/or deployment system 1306. In at least one embodiment, GPUs/Graphics 1422 (e.g., NVIDIA's TESLA and/or QUADRO GPUs) may include any number of GPUs that may be used for executing processing tasks of compute service(s) 1416, AI service(s) 1418, visualization service(s) 1420, other services, and/or any of features or functionality of software 1318. For example, with respect to AI service(s) 1418, GPUs/Graphics 1422 may be used to perform pre-processing on imaging data (or other data types used by machine learning models), post-processing on outputs of machine learning models, and/or to perform inferencing (e.g., to execute machine learning models). In at least one embodiment, cloud 1426, AI system 1424, and/or other components of system 1400 may use GPUs/Graphics 1422. In at least one embodiment, cloud 1426 may include a GPU-optimized platform for deep learning tasks. In at least one embodiment, AI system 1424 may use GPUs, and cloud 1426—or at least a portion tasked with deep learning or inferencing—may be executed using one or more AI systems 1424. As such, although hardware 1322 is illustrated as discrete components, this is not intended to be limiting, and any components of hardware 1322 may be combined with, or leveraged by, any other components of hardware 1322.

In at least one embodiment, AI system 1424 may include a purpose-built computing system (e.g., a super-computer or an HPC) configured for inferencing, deep learning, machine learning, and/or other artificial intelligence tasks. In at least one embodiment, AI system 1424 (e.g., NVIDIA's DGX) may include GPU-optimized software (e.g., a software stack) that may be executed using a plurality of GPUs/Graphics 1422, in addition to CPUs, RAM, storage, and/or other components, features, or functionality. In at least one embodiment, one or more AI systems 1424 may be implemented in cloud 1426 (e.g., in a data center) for performing some or all of AI-based processing tasks of system 1400.

In at least one embodiment, cloud 1426 may include a GPU-accelerated infrastructure (e.g., NVIDIA's NGC) that may provide a GPU-optimized platform for executing processing tasks of system 1400. In at least one embodiment, cloud 1426 may include an AI system 1424 for performing one or more of AI-based tasks of system 1400 (e.g., as a hardware abstraction and scaling platform). In at least one embodiment, cloud 1426 may integrate with application orchestration system 1428 leveraging multiple GPUs to enable seamless scaling and load balancing between and among applications and services 1320. In at least one embodiment, cloud 1426 may tasked with executing at least some of services 1320 of system 1400, including compute service(s) 1416, AI service(s) 1418, and/or visualization service(s) 1420, as described herein. In at least one embodiment, cloud 1426 may perform small and large batch inference (e.g., executing NVIDIA's TENSOR RT), provide an accelerated parallel computing API and platform 1430 (e.g., NVIDIA's CUDA), execute application orchestration system 1428 (e.g., KUBERNETES), provide a graphics rendering API and platform (e.g., for ray-tracing, 2D graphics, 3D graphics, and/or other rendering techniques to produce higher quality cinematics), and/or may provide other functionality for system 1400.

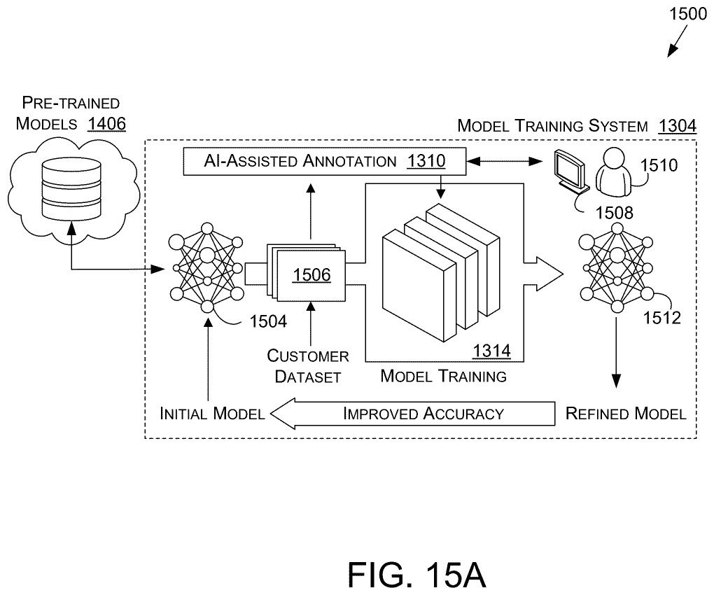

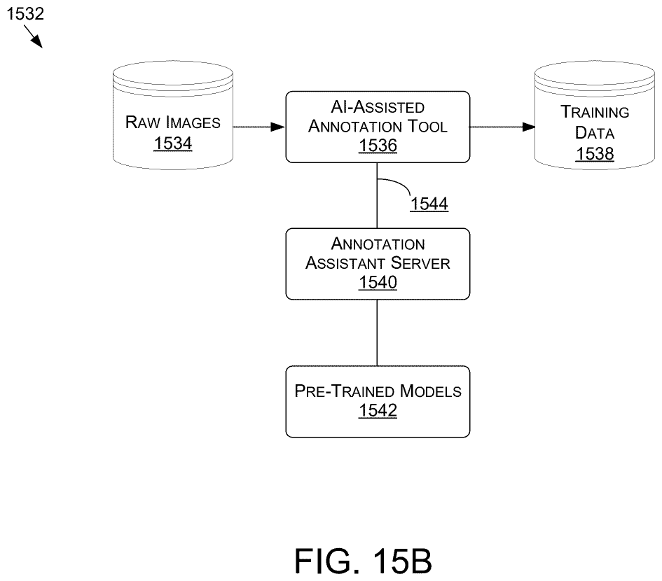

FIG. 15A illustrates a data flow diagram for a process 1500 to train, retrain, or update a machine learning model, in accordance with at least one embodiment. In at least one embodiment, process 1500 may be executed using, as a non-limiting example, system 1400 of FIG. 14. In at least one embodiment, process 1500 may leverage services and/or hardware as described herein. In at least one embodiment, refined models 1512 generated by process 1500 may be executed by a deployment system for one or more containerized applications in deployment pipelines.

In at least one embodiment, model training 1514 may include retraining or updating an initial model 1504 (e.g., a pre-trained model) using new training data (e.g., new input data, such as customer dataset 1506, and/or new ground truth data associated with input data). In at least one embodiment, to retrain, or update, initial model 1504, output or loss layer(s) of initial model 1504 may be reset, deleted, and/or replaced with an updated or new output or loss layer(s). In at least one embodiment, initial model 1504 may have previously fine-tuned parameters (e.g., weights and/or biases) that remain from prior training, so training or retraining 1514 may not take as long or require as much processing as training a model from scratch. In at least one embodiment, during model training 1514, by having reset or replaced output or loss layer(s) of initial model 1504, parameters may be updated and re-tuned for a new data set based on loss calculations associated with accuracy of output or loss layer(s) at generating predictions on new, customer dataset 1506.

In at least one embodiment, pre-trained models 1506 may be stored in a data store, or registry. In at least one embodiment, pre-trained models 1506 may have been trained, at least in part, at one or more facilities other than a facility executing process 1500. In at least one embodiment, to protect privacy and rights of patients, subjects, or clients of different facilities, pre-trained models 1506 may have been trained, on-premise, using customer or patient data generated on-premise. In at least one embodiment, pre-trained models 1306 may be trained using a cloud and/or other hardware, but confidential, privacy protected patient data may not be transferred to, used by, or accessible to any components of a cloud (or other off premise hardware). In at least one embodiment, where pre-trained models 1506 is trained at using patient data from more than one facility, pre-trained models 1506 may have been individually trained for each facility prior to being trained on patient or customer data from another facility. In at least one embodiment, such as where a customer or patient data has been released of privacy concerns (e.g., by waiver, for experimental use, etc.), or where a customer or patient data is included in a public data set, a customer or patient data from any number of facilities may be used to train pre-trained models 1506 on-premise and/or off premise, such as in a datacenter or other cloud computing infrastructure.

In at least one embodiment, when selecting applications for use in deployment pipelines, a user may also select machine learning models to be used for specific applications. In at least one embodiment, a user may not have a model for use, so a user may select a pre-trained model to use with an application. In at least one embodiment, pre-trained model may not be optimized for generating accurate results on customer dataset 1506 of a facility of a user (e.g., based on patient diversity, demographics, types of medical imaging devices used, etc.). In at least one embodiment, prior to deploying a pre-trained model into a deployment pipeline for use with an application(s), pre-trained model may be updated, retrained, and/or fine-tuned for use at a respective facility.

In at least one embodiment, a user may select pre-trained model that is to be updated, retrained, and/or fine-tuned, and this pre-trained model may be referred to as initial model 1504 for a training system within process 1500. In at least one embodiment, a customer dataset 1506 (e.g., imaging data, genomics data, sequencing data, or other data types generated by devices at a facility) may be used to perform model training (which may include, without limitation, transfer learning) on initial model 1504 to generate refined model 1512. In at least one embodiment, ground truth data corresponding to customer dataset 1506 may be generated by training system 1304. In at least one embodiment, ground truth data may be generated, at least in part, by clinicians, scientists, doctors, practitioners, at a facility.

In at least one embodiment, AI-assisted annotation may be used in some examples to generate ground truth data. In at least one embodiment, AI-assisted annotation (e.g., implemented using an AI-assisted annotation SDK) may leverage machine learning models (e.g., neural networks) to generate suggested or predicted ground truth data for a customer dataset. In at least one embodiment, a user may use annotation tools within a user interface (a graphical user interface (GUI)) on a computing device.

In at least one embodiment, user 1510 may interact with a GUI via computing device 1508 to edit or fine-tune (auto) annotations. In at least one embodiment, a polygon editing feature may be used to move vertices of a polygon to more accurate or fine-tuned locations.

In at least one embodiment, once customer dataset 1506 has associated ground truth data, ground truth data (e.g., from AI-assisted annotation, manual labeling, etc.) may be used by during model training to generate refined model 1512. In at least one embodiment, customer dataset 1506 may be applied to initial model 1504 any number of times, and ground truth data may be used to update parameters of initial model 1504 until an acceptable level of accuracy is attained for refined model 1512. In at least one embodiment, once refined model 1512 is generated, refined model 1512 may be deployed within one or more deployment pipelines at a facility for performing one or more processing tasks with respect to medical imaging data.

In at least one embodiment, refined model 1512 may be uploaded to pre-trained models in a model registry to be selected by another facility. In at least one embodiment, this process may be completed at any number of facilities such that refined model 1512 may be further refined on new datasets any number of times to generate a more universal model.

FIG. 15B is an example illustration of a client-server architecture 1532 to enhance annotation tools with pre-trained annotation models, in accordance with at least one embodiment. In at least one embodiment, AI-assisted annotation tool 1536 may be instantiated based on a client-server architecture 1532. In at least one embodiment, AI-assisted annotation tool 1536 in imaging applications may aid radiologists, for example, identify organs and abnormalities. In at least one embodiment, imaging applications may include software tools that help user 1510 to identify, as a non-limiting example, a few extreme points on a particular organ of interest in raw images 1534 (e.g., in a 3D MRI or CT scan) and receive auto-annotated results for all 2D slices of a particular organ. In at least one embodiment, results may be stored in a data store as training data 1538 and used as (for example and without limitation) ground truth data for training. In at least one embodiment, when computing device 1508 sends extreme points for AI-assisted annotation, a deep learning model, for example, may receive this data as input and return inference results of a segmented organ or abnormality. In at least one embodiment, pre-instantiated annotation tools, such as AI-assisted annotation tool 1536 in FIG. 15B, may be enhanced by making API calls (e.g., API Call 1544) to a server, such as an Annotation Assistant Server 1540 that may include a set of pre-trained models 1542 stored in an annotation model registry, for example. In at least one embodiment, an annotation model registry may store pre-trained models 1542 (e.g., machine learning models, such as deep learning models) that are pre-trained to perform AI-assisted annotation on a particular organ or abnormality. These models may be further updated by using training pipelines. In at least one embodiment, pre-installed annotation tools may be improved over time as new labeled data is added.

Various embodiments can be described by the following clauses:

1. A computer-implemented method, comprising:
generating an image feature map corresponding to a two-dimensional (2D) query image;
identifying, as a set of coarse matches, a number of reference feature vectors closest to image feature vectors of the image feature map in a latent feature space, the reference feature vectors corresponding to three-dimensional (3D) points in a 3D environment reconstructed using a neural radiance field (NeRF) trained on a set of reference images of the 3D environment; and determining, using a fine matching network and starting from locations selected based on the set of coarse matches, a camera pose corresponding to the 2D query image with respect to the 3D environment.

2. The computer-implemented method of clause 1, wherein the camera pose is determined for at least one query image of a set of 2D query images without retraining the NeRF.

3. The computer-implemented method of clause 1, further comprising:
obtaining, for individual coarse matches of the set of coarse matches, an image patch feature from a fine feature map associated with a corresponding location of the individual coarse match.

4. The computer-implemented method of clause 3, further comprising:
aligning individual point features with corresponding local map features to determine probabilities of the individual point features corresponding to pixels in a vicinity of a determined image pixel.

5. The computer-implemented method of clause 3, further comprising:
analyzing a probability distribution corresponding to determined probabilities to obtain a set of refined feature matches; and
determining the camera pose based in part upon the set of refined feature matches.

6. The computer-implemented method of clause 1, wherein the camera pose is determined by processing, using a perspective-n-point (PnP) solver, a set of fine matches output by the fine matching network.

7. The computer-implemented method of clause 1, further comprising:
generating image feature maps for the 2D query image at two different resolutions, wherein a lower resolution 2D feature map of the image feature maps is used to determine the set of coarse matches, and wherein a higher resolution 2D feature map of the image feature maps is used by the fine matching network to determine the camera pose.

8. The computer-implemented method of clause 7, wherein the fine matching network receives input based upon feature sampling of the set of coarse matches and the higher resolution 2D image feature map.

9. At least one processor comprising one or more circuits to:
generate an image feature map corresponding to a two-dimensional (2D) query image;
identify, as a set of coarse matches, a number of reference feature vectors being closest to image feature vectors of the image feature map in a latent feature space, the reference feature vectors corresponding to reference images used to train a neural radiance field (NeRF) to reconstruct a region of a three-dimensional (3D) environment; and
determine, using a fine matching network and starting from locations for the set of coarse matches, a camera pose corresponding to the 2D query image with respect to the 3D environment.

10. The processor of clause 9, wherein the one or more circuits are further to:
obtain, for individual coarse matches of the set, an image patch feature from a fine feature map associated with a corresponding location of the individual coarse match.

11. The at least one processor of clause 10, wherein the one or more circuits are further to:
align individual point features with corresponding local map features to determine probabilities of the individual point features corresponding to pixels in a vicinity of a determined image pixel.

12. The at least one processor of clause 9, wherein the one or more circuits are further to:
analyze a probability distribution, corresponding to determined probabilities, to obtain a set of refined feature matches; and
determine the camera pose based in part upon the set of refined feature matches.

13. The at least one processor of clause 9, wherein the camera pose is determined using a perspective-n-point (PnP) solver processing a set of fine matches output by the fine matching network.

14. The at least one processor of clause 9, wherein the one or more circuits are further to:
generate image feature maps for the 2D query image at two different resolutions, wherein a lower resolution 2D feature map of the image feature maps is used to determine the set of coarse matches, and wherein a higher resolution 2D feature map of the image feature maps is used by the fine matching network to determine the camera pose.

15. The at least one processor of clause 9, wherein the processor is comprised in at least one of:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center;
a system for performing hardware testing using simulation;
a system for synthetic data generation;
a system for performing generative AI operations using a large language model (LLM);
a system for performing generative AI operations using a vision language model (VLM);
a system implemented using one or more multi-modal language models;
a system using or deploying one or more inference microservices;
a system that incorporates one or more machine learning models deployed in a service or microservice along with an OS-level virtualization package (e.g., a container);
a collaborative content creation platform for 3D assets; or
a system implemented at least partially using cloud computing resources.

16. A system comprising:
one or more processors to determine a camera pose of a two-dimensional (2D) query image with respect to a three-dimensional (3D) environment by identifying a set of coarse matches based in part upon comparing a feature map of the query image against a set of reference feature vectors corresponding to a neural field representation (NeRF) of the 3D environment, and using a fine matching network with the set of coarse matches to generate a set of fine matches useable to determine the camera pose.

17. The system of clause 16, wherein the one or more processors are further to:
obtain, for individual coarse matches of the set of coarse matches, an image patch feature from a fine feature map associated with a corresponding location of the individual coarse match.

18. The system of clause 17, wherein the one or more processors are further to:
increase a feature dimensionality of individual point features associated with the coarse matches; and
align the individual point features, with the increased feature dimensionality, with corresponding local map features to determine probabilities of the individual point features corresponding to pixels in a vicinity of an determined image pixel.

19. The system of clause 16, wherein the one or more processors are further to:
analyze a probability distribution, corresponding to determined probabilities, to obtain a set of refined feature matches; and determine the camera pose based in part upon the set of refined feature matches.

20. The system of clause 16, wherein the system comprises at least one of:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system for performing generative AI operations using a large language model (LLM);
a system for performing generative AI operations using a vision language model (VLM);
a system implemented using one or more multi-modal language models;
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center;
a system for performing hardware testing using simulation;
a system for synthetic data generation;
a system using or deploying one or more inference microservices;
a system that incorporates one or more machine learning models deployed in a service or microservice along with an OS-level virtualization package (e.g., a container);
a collaborative content creation platform for 3D assets; or
a system implemented at least partially using cloud computing resources.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. Term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. Use of term “set” (e.g., “a set of items”) or “subset,” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B, and at least one of C each to be present. In addition, unless otherwise noted or contradicted by context, term “plurality” indicates a state of being plural (e.g., “a plurality of items” indicates multiple items). A plurality is at least two items, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. A set of non-transitory computer-readable storage media, in at least one embodiment, comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. Terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. Obtaining, acquiring, receiving, or inputting analog and digital data can be accomplished in a variety of ways such as by receiving data as a parameter of a function call or a call to an application programming interface. In some implementations, process of obtaining, acquiring, receiving, or inputting analog or digital data can be accomplished by transferring data via a serial or parallel interface. In another implementation, process of obtaining, acquiring, receiving, or inputting analog or digital data can be accomplished by transferring data via a computer network from providing entity to acquiring entity. References may also be made to providing, outputting, transmitting, sending, or presenting analog or digital data. In various examples, process of providing, outputting, transmitting, sending, or presenting analog or digital data can be accomplished by transferring data as an input or output parameter of a function call, a parameter of an application programming interface or interprocess communication mechanism.

Although discussion above sets forth example implementations of described techniques, other architectures may be used to implement described functionality, and are intended to be within scope of this disclosure. Furthermore, although specific distributions of responsibilities are defined above for purposes of discussion, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A computer-implemented method, comprising:
generating an image feature map corresponding to a two-dimensional (2D) query image;
identifying, as a set of coarse matches, a number of reference feature vectors closest to image feature vectors of the image feature map in a latent feature space, the reference feature vectors corresponding to three-dimensional (3D) points in a 3D environment reconstructed using a neural radiance field (NeRF) trained on a set of reference images of the 3D environment; and
determining, using a fine matching network and starting from locations selected based on the set of coarse matches, a camera pose corresponding to the 2D query image with respect to the 3D environment.

2. The computer-implemented method of claim 1, wherein the camera pose is determined for at least one query image of a set of 2D query images without retraining the NeRF.

3. The computer-implemented method of claim 1, further comprising:
obtaining, for individual coarse matches of the set of coarse matches, an image patch feature from a fine feature map associated with a corresponding location of the individual coarse match.

4. The computer-implemented method of claim 3, further comprising:
aligning individual point features with corresponding local map features to determine probabilities of the individual point features corresponding to pixels in a vicinity of a determined image pixel.

5. The computer-implemented method of claim 3, further comprising:
analyzing a probability distribution corresponding to determined probabilities to obtain a set of refined feature matches; and
determining the camera pose based in part upon the set of refined feature matches.

6. The computer-implemented method of claim 1, wherein the camera pose is determined by processing, using a perspective-n-point (PnP) solver, a set of fine matches output by the fine matching network.

7. The computer-implemented method of claim 1, further comprising:
generating image feature maps for the 2D query image at two different resolutions, wherein a lower resolution 2D feature map of the image feature maps is used to determine the set of coarse matches, and wherein a higher resolution 2D feature map of the image feature maps is used by the fine matching network to determine the camera pose.

8. The computer-implemented method of claim 7, wherein the fine matching network receives input based upon feature sampling of the set of coarse matches and the higher resolution 2D image feature map.

9. At least one processor comprising one or more circuits to:
generate an image feature map corresponding to a two-dimensional (2D) query image;
identify, as a set of coarse matches, a number of reference feature vectors being closest to image feature vectors of the image feature map in a latent feature space, the reference feature vectors corresponding to reference images used to train a neural radiance field (NeRF) to reconstruct a region of a three-dimensional (3D) environment; and
determine, using a fine matching network and starting from locations for the set of coarse matches, a camera pose corresponding to the 2D query image with respect to the 3D environment.

10. The processor of claim 9, wherein the one or more circuits are further to:
obtain, for individual coarse matches of the set, an image patch feature from a fine feature map associated with a corresponding location of the individual coarse match.

11. The at least one processor of claim 10, wherein the one or more circuits are further to:
align individual point features with corresponding local map features to determine probabilities of the individual point features corresponding to pixels in a vicinity of a determined image pixel.

12. The at least one processor of claim 9, wherein the one or more circuits are further to:
analyze a probability distribution, corresponding to determined probabilities, to obtain a set of refined feature matches; and
determine the camera pose based in part upon the set of refined feature matches.

13. The at least one processor of claim 9, wherein the camera pose is determined using a perspective-n-point (PnP) solver processing a set of fine matches output by the fine matching network.

14. The at least one processor of claim 9, wherein the one or more circuits are further to:
generate image feature maps for the 2D query image at two different resolutions, wherein a lower resolution 2D feature map of the image feature maps is used to determine the set of coarse matches, and wherein a higher resolution 2D feature map of the image feature maps is used by the fine matching network to determine the camera pose.

15. The at least one processor of claim 9, wherein the processor is comprised in at least one of:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center;
a system for performing hardware testing using simulation;
a system for synthetic data generation;
a system for performing generative AI operations using a large language model (LLM);
a system for performing generative AI operations using a vision language model (VLM);
a system implemented using one or more multi-modal language models;
a system using or deploying one or more inference microservices;
a system that incorporates one or more machine learning models deployed in a service or microservice along with an OS-level virtualization package (e.g., a container);
a collaborative content creation platform for 3D assets; or
a system implemented at least partially using cloud computing resources.

16. A system comprising:
one or more processors to determine a camera pose of a two-dimensional (2D) query image with respect to a three-dimensional (3D) environment by identifying a set of coarse matches based in part upon comparing a feature map of the query image against a set of reference feature vectors corresponding to a neural field representation (NeRF) of the 3D environment, and using a fine matching network with the set of coarse matches to generate a set of fine matches useable to determine the camera pose.

17. The system of claim 16, wherein the one or more processors are further to:
obtain, for individual coarse matches of the set of coarse matches, an image patch feature from a fine feature map associated with a corresponding location of the individual coarse match.

18. The system of claim 17, wherein the one or more processors are further to:
increase a feature dimensionality of individual point features associated with the coarse matches; and
align the individual point features, with the increased feature dimensionality, with corresponding local map features to determine probabilities of the individual point features corresponding to pixels in a vicinity of an determined image pixel.

19. The system of claim 16, wherein the one or more processors are further to:
analyze a probability distribution, corresponding to determined probabilities, to obtain a set of refined feature matches; and
determine the camera pose based in part upon the set of refined feature matches.

20. The system of claim 16, wherein the system comprises at least one of:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system for performing generative AI operations using a large language model (LLM);
a system for performing generative AI operations using a vision language model (VLM);
a system implemented using one or more multi-modal language models;
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center;
a system for performing hardware testing using simulation;
a system for synthetic data generation;
a system using or deploying one or more inference microservices;
a system that incorporates one or more machine learning models deployed in a service or microservice along with an OS-level virtualization package (e.g., a container);
a collaborative content creation platform for 3D assets; or
a system implemented at least partially using cloud computing resources.
